(19) United States
(12) Patent Application Publication
(10) Pub. No.: US 2012/0244881 A1
(43) Pub. Date: Sep. 27, 2012

(54) POSITION-DETERMINING DEVICE, POSITION-DETERMINING SYSTEM, POSITION-DETERMINING METHOD AND PROGRAM

(75) Inventor: Yusuke Konishi, Tokyo (JP)

(73) Assignee: NEC CORPORATION, Tokyo (JP)

(21) Appl. No.: 13/514,898

(22) PCT Filed: Dec. 1, 2010
(86) PCT No.: PCT/JP2010/071476

§ 371 Date: Jun. 8, 2012

(30) Foreign Application Priority Data
Dec. 9, 2009 (JP) 2009-279393
Mar. 10, 2010 (JP) 2010-052879

(51) Int. Cl. H04W 24/00

(52) U.S. Cl. 455/456.1

(57) ABSTRACT

Disclosed is a position-detection technology that can correctly detect the position of a wireless machine attached to a mobile body, even if there are few reference wireless machines installed in the environment in which the position of the mobile body is to be determined. The means for achieving the above is characterized by retrieving from a feature quantity recording unit a reception feature quantity approximating the reception feature quantity calculated from radio wave strength of the mobile station that moves within the aforementioned environment, and determining the position information associated with the retrieved reception feature quantity to be of the position of the aforementioned mobile station.

### TECHNICAL FIELD

The present invention relates to a position-determining device, a position-determining system, a position-determining method, and a program therefor.

### BACKGROUND ART

The systems utilizing a GPS, a wireless LAN, an RFID, infrared-rays, an ultrasonic wave, and the like have been proposed as a system for detecting positions of terminals attached to mobile bodies such as persons and things. The system for detecting positions of terminals attached to the mobile bodies by employing various media such as wireless, the ultrasonic, and the infrared-rays is described in Non-patent literature 1.

In the system employing wireless machines such as the wireless LAN and the RFID, out of such position detection systems, the technology has been proposed of installing the wireless machines having a function similar to the function of a thing attached to the mobile body in an environment for reference so as to realize a high precision and a low cost of the above position detection. In Non-patent literature 2, the technology is described of realizing the high precision in estimating position coordinates of tags in an active RFID system by referencing the tags densely installed in the environment. Further, in Patent literature 1, the technology is described of realizing a reduction in the cost of the position detection system by comparing a wireless situation to be measured by a wireless machine attached to the mobile body with the wireless situation to be measured by a reference wireless machine previously installed in each area.

### CITATION LIST

### Patent Literature

PTL 1: JP-2006-308361A

### Non-Patent Literature

NON-PTL 1: G Chen and D. Kotz, A Survey of Context-Aware Mobile Computing Research, Technical Report 381, Department of Computer Science, Dartmouth College, 2000

NON-PTL 2: Lionel M. Ni, Yunhao Liu, Yiu Cho Lau and Abhishek P, Patil, LANDMARC: Indoor Location Sensing Using Active RFID, PerCom2003

### SUMMARY OF INVENTION

### Technical Problem

A point at issue is that when there are few reference wireless machines installed in the environment, the position of the wireless machine attached to the mobile body cannot be correctly detected.

The reason is that a difference between the wireless situation to be measured by the reference wireless machine and the wireless situation to be measured by the wireless machine attached to the mobile body becomes large due to a fluctuation in the special characteristic of the wireless environment caused by dynamic obstacles within the environment, how to attach the wireless machine to the mobile body and the like, and due to the fact that the number of the reference wireless machines that can be installed within the area having some space is restricted.

The present invention has been accomplished in consideration of the above-mentioned problems, and an object thereof is to provide a system capable of correctly detecting the wireless machine attached to the mobile body even if there are few reference wireless machines installed in the environment in which the position of the mobile body is to be determined, and a technology thereof.

### Means to Solve the Problem

The present invention for solving the above-mentioned problems, which is a position-determining device, is characterized in including a storage controlling unit that decides a reception feature quantity of each area pre-defined in a predetermined environment by employing the reception feature quantity of a mobile station in the above area calculated from radio wave strength of the mobile station attached to a mobile body that moves within the aforementioned environment, and causes a feature quantity storing unit to store position information indicating a position of each area and the decided reception feature quantity correspondingly to each other, and a position-determining unit that retrieves, from the aforementioned feature quantity storing unit, the reception feature quantity approximating the reception feature quantity calculated from the radio wave strength of the mobile station attached to the mobile body that moves within the aforementioned environment, and determines the position information caused to correspond to the retrieved reception feature quantity to be of the position of the aforementioned mobile station.

The present invention for solving the above-mentioned problems, which is a position-determining system, is characterized in including a storage controlling unit that decides a reception feature quantity of each area pre-defined in a predetermined environment by employing the reception feature quantity of a mobile station in the above area calculated from radio wave strength of the mobile station attached to a mobile body that moves within the aforementioned environment, and causes a feature quantity storing unit to store position information indicating a position of each area and the decided reception feature quantity correspondingly to each other, and a position-determining unit that retrieves, from the aforementioned feature quantity storing unit, the reception feature quantity approximating the reception feature quantity calculated from the radio wave strength of the mobile station attached to the mobile body that moves within the aforementioned environment, and determines the position information caused to correspond to the retrieved reception feature quantity to be of the position of the aforementioned mobile station.

The present invention for solving the above-mentioned problems, which is a position-determining method, is characterized in including a storage controlling step of deciding a reception feature quantity of each area pre-defined in a predetermined environment by employing the reception feature quantity of a mobile station in the above area calculated from radio wave strength of the mobile station attached to a mobile body that moves within the aforementioned environment, and causing a feature quantity storing unit to store position information indicating a position of each area and the decided reception feature quantity correspondingly to each other, and a position-determining step of retrieving, from the aforementioned feature quantity storing unit, the reception feature quantity approximating the reception feature quantity calculated from the radio wave strength of the mobile station attached to the mobile body that moves within the aforementioned environment, and determining the position information caused to correspond to the retrieved reception feature quantity to be of the position of the aforementioned mobile station.

The present invention for solving the above-mentioned problems, which is a program of a position-determining device, is characterized in causing the aforementioned position-determining device to execute a storage controlling process of deciding a reception feature quantity of each area pre-defined in a predetermined environment by employing the reception feature quantity of a mobile station in the above area calculated from radio wave strength of the mobile station attached to a mobile body that moves within the aforementioned environment, and causing a feature quantity storing unit to store position information indicating a position of each area and the decided reception feature quantity correspondingly to each other, and a position-determining process of retrieving, from the aforementioned feature quantity storing unit, the reception feature quantity approximating the reception feature quantity calculated from the radio wave strength of the mobile station attached to the mobile body that moves within the aforementioned environment, and determining the position information caused to correspond to the retrieved reception feature quantity to be of the position of the aforementioned mobile station.

### Advantageous Effect of Invention

An advantageous effect of the present invention lies in a point of correctly detecting the position of the wireless machine attached to the mobile body notwithstanding few reference wireless machines.

### BRIEF DESCRIPTION OF DRAWINGS

FIG. 1 is a view illustrating an outline of a first exemplary embodiment.

FIG. 2 is a block diagram illustrating a configuration of the first exemplary embodiment.

FIG. 3 is a view illustrating an example of the reception feature quantity.

FIG. 4 is a view illustrating an example of information to be recorded into a position reception feature quantity storage.

FIG. 5 is a flowchart illustrating an operation of the first exemplary embodiment.

FIG. 6 is a flowchart illustrating an operation of the first exemplary embodiment.

FIG. 7 is a flowchart illustrating an operation of the first exemplary embodiment.

FIG. 8 is a block diagram illustrating a configuration of a second exemplary embodiment.

FIG. 9 is a block diagram illustrating an example of the second exemplary embodiment.

FIG. 10 is a flowchart illustrating an operation of the second exemplary embodiment.

FIG. 11 is a view illustrating an outline of a sixth exemplary embodiment.

FIG. 12 is a block diagram illustrating a configuration of the sixth exemplary embodiment.

FIG. 13 is a flowchart illustrating an operation of the sixth exemplary embodiment.

FIG. 14 is a block diagram illustrating a configuration of a seventh exemplary embodiment.

FIG. 15 is a block diagram illustrating a configuration of the seventh exemplary embodiment.

FIG. 16 is a view for explain the characteristics of the present invention.

FIG. 17 is a block diagram illustrating a configuration of the third exemplary embodiment of the present invention.

FIG. 18 is a view illustrating an example of a difference feature quantity.

FIG. 19 is a view illustrating an example of information to be recorded into a difference feature quantity storage.

FIG. 20 is a block diagram illustrating an operation of the third exemplary embodiment of the present invention.

FIG. 21 is a flowchart illustrating an operation of the third exemplary embodiment of the present invention.

FIG. 22 is a block diagram illustrating an operation of the third exemplary embodiment of the present invention.

FIG. 23 is a flowchart illustrating an operation of the third exemplary embodiment of the present invention.

FIG. 24 is a block diagram illustrating a configuration of a fourth exemplary embodiment of the present invention.

FIG. 25 is a block diagram illustrating a configuration of a fifth exemplary embodiment of the present invention.

FIG. 26 is a block diagram illustrating a configuration of the fifth exemplary embodiment of the present invention.

### DESCRIPTION OF EMBODIMENTS

So as to explain the characteristics of the present invention, the exemplary embodiments will be described by referencing the accompanied drawings.

FIG. 16 is a view for explaining the characteristics of the present invention.

The present invention includes a storage controlling unit, a reception feature quantity storage, and a position-determining unit.

In the present invention, the storage controlling unit decides the reception feature quantity of each area pre-defined in a predetermined environment by employing the reception feature quantity of the mobile station in the above area calculated from the radio wave strength of the mobile station attached to the mobile body that moves within the environment. This decided reception feature quantity and the position information indicating a position of each area are stored correspondingly to each other in the reception feature quantity storage. The present invention is characterized in that the position-determining unit retrieves, from the reception feature quantity storage for storing the position information and the feature quantity correspondingly to each other, the reception feature quantity approximating the reception feature quantity calculated from the radio wave strength of the mobile station attached to the mobile body that moves within the environment, and determines the position information caused to correspond to the retrieved reception feature quantity to be of the position of the aforementioned mobile station. Additionally, the so-called environment is indicative of a physical space into which the present invention is introduced. For example, when the position of the mobile station is determined within a certain building or site, the physical space of the above building or the site is the environment.

### First Exemplary Embodiment

Next, the first exemplary embodiment for carrying out the present invention will be explained in details by referencing the accompanied drawings.

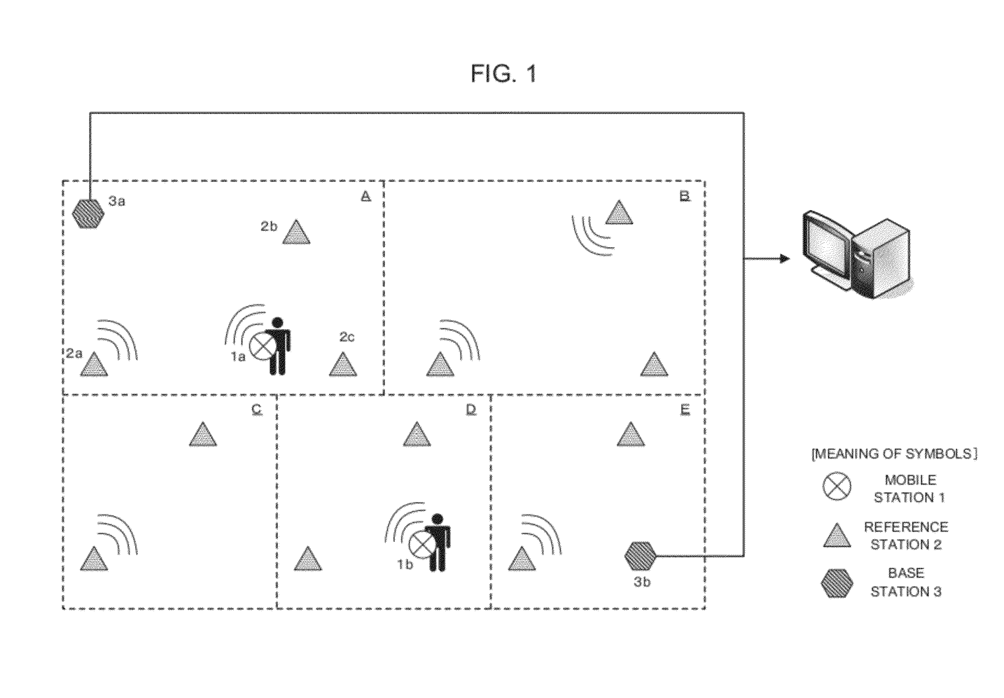

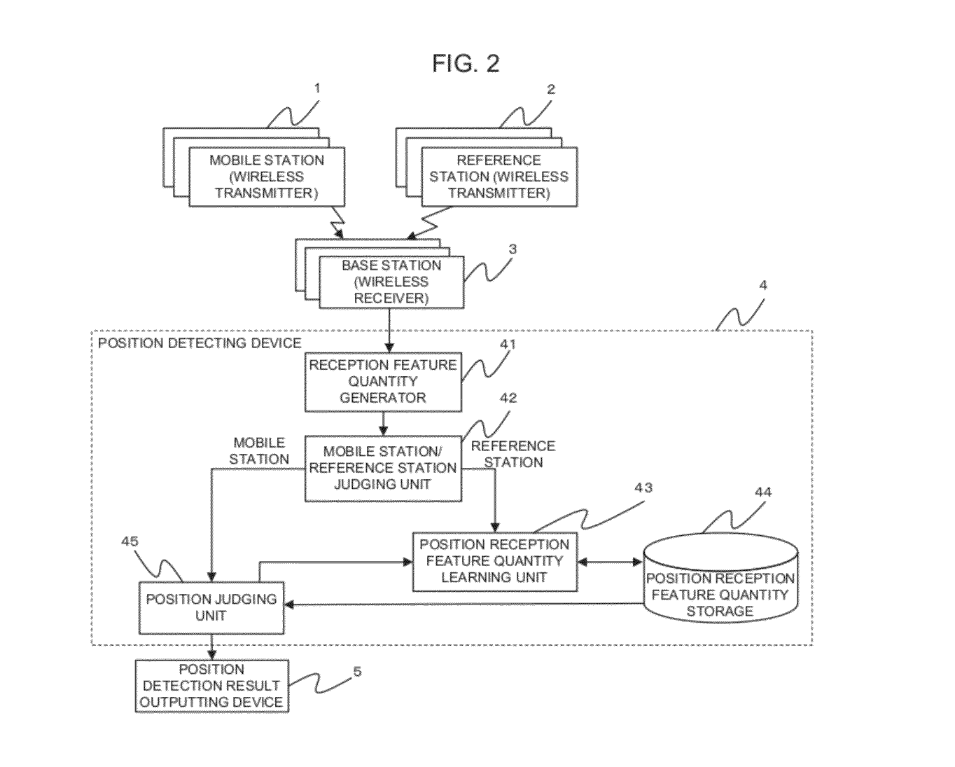

By referencing FIG. 1 and FIG. 2, the first exemplary embodiment of the present invention includes a mobile station 1, a reference station 2, a base station 3, a position detection device 4, and a position detection result outputting device 5 for outputting a position detection result.

The mobile station 1, which is attached to s detection target such as the mobile body, transmits identification information for identifying the device by use of the wireless communication every constant time interval.

The reference station 2, which is correspondingly installed in the pre-defined area within the environment, transmits the identification information for identifying the device by use of the wireless communication every constant time interval.

The base station 3 receives the identification information to be transmitted by the mobile station 1 and the reference station 2, and measures a numerical value (hereinafter, referred to as reception intensity) indicating the strength of the radio wave at the time of having received respective pieces of the identification information. The base station 3 outputs a set of the acquired identification information of the mobile station 1 or the reference station 2 and the reception strength together with the identification information of the base station 3 as the reception result to a reception feature quantity generator 41.

Additionally, at least one reference station 2 or more needs to be installed in each pre-defined area. Further, the base stations 3 do not always need to be installed in a plural number, and the base stations 3 could be single.

In addition, each of the mobile station 1 and the reference station 2 does not always need to transmit the identification information every constant time interval, and for example, may dynamically change the time interval at which the identification information is transmitted responding to a time zone, a movement speed of the mobile body, and the like in some cases, or may transmit the identification information when receiving an instruction coming from a user, being the mobile body, the position detection device, and the like in some cases.

The position detection device 4 detects the area in which the mobile station 1 exists by employing the reception result of the mobile station 1 and the reference station 2 obtained by the base station 3. The position detection device 4 includes the reception feature quantity generator 41, a mobile station/reference station judging unit 42, a position reception feature quantity learning unit 43, a position reception feature quantity storage 44, and a position judging unit 45.

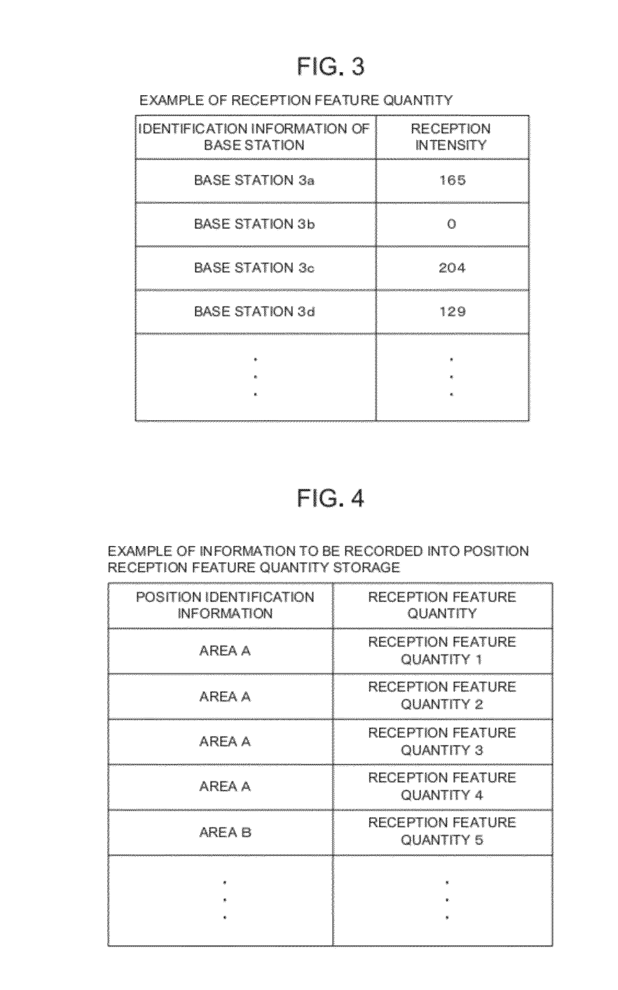

The reception feature quantity generator 41 generates the reception feature quantity of each of the mobile station 1 and the reference station 2 from the reception results of the mobile station 1 and the reference station 2 obtained by the base station 3, and outputs it together with the corresponding identification information. The reception feature quantity is expressed with a feature vector having the reception strength for each of all the base stations 3 as a component. For example, the reception feature quantity, as shown in FIG. 3, behaves like (base station 3a, base station 3b, base station 3c, base station 3d, . . . )=(165, 0, 304, 129, . . . ).

The mobile station/reference station judging unit 42 judges whether the reception feature quantity generated by the reception feature quantity generator 41 is related to the mobile station 1 or the reference station 2 based on the corresponding identification information, and outputs the reception feature quantity related to the mobile station 1 to the position judging unit 45, and the reception feature quantity related to the reference station 2 together with the identification information of the area in which the reference station 2 has been installed to the position reception feature quantity learning unit 43, respectively. At this time, so as to judge whether the reception feature quantity is related to the mobile station 1 or the reference station 2 from the corresponding identification information, the mobile station/reference station judging unit 42 may pre-incorporate such information that enables the mobile station 1 and the reference station 2 to be differentiated from each other into the identification information in some cases, or may record identification information that enables the mobile station 1 and the reference station 2 to be differentiated from each other into a database etc. in some cases. Further, so as to obtain the identification information of the area in which the reference station 2 has been installed from the identification information of the reference station 2, the mobile station/reference station judging unit 42 may pre-incorporate the identification information of the area in which the reference station 2 has been installed into the identification information of the reference station 2 in some cases, or may record correspondence between the identification information of the reference station 2 and the identification information of the area in which the reference station 2 has been installed into the database etc.

The position reception feature quantity learning unit 43 learns the by-area reception feature quantities including a tendency of the past reception feature quantities that are inputted from the mobile station/reference station judging unit 42 and the position judging unit 45, and records them into the position reception feature quantity storage 44. An example of the content to be recorded into the position reception feature quantity storage 44 is shown in FIG. 4. As shown in FIG. 4, at least one reception feature quantity or more is recorded for each area together with position identification information for identifying the area into the position reception feature quantity storage 44. Hereinafter, a set of the position identification information and the reception feature quantity is called a position reception feature quantity, and the by-area reception feature quantity to be recorded into the position reception feature quantity storage 44 is called a by-area representative reception feature quantity.

As a specific example of the position reception feature quantity learning unit 43, all the position reception feature quantities to be inputted are recorded as the by-area representative reception feature quantity into the position reception feature quantity storage 44. At this time, the representative reception feature quantities recorded ahead of a designated constant time may be deleted from the position reception feature quantity storage 44.

As another specific example of the position reception feature quantity learning unit 43, the position reception feature quantity to be inputted is defined as teacher's data, and the representative reception feature quantity of each area is learned with self-organizing maps and learning vector quantization (literature to be referenced: Kohonen, Self-Organizing Maps, Springer-Verlag Tokyo, June, 2005)

The position judging unit 45 retrieves the reception feature quantity approximating the reception feature quantity related to the mobile station 1, which is inputted from the mobile station/reference station judging unit 42, from the by-area representative reception feature quantities recorded into the position reception feature quantity storage 44, and outputs the position identification information corresponding to the retrieved representative reception feature quantity as a position detection result. In addition, at this time, the position judging unit 45 assumes that the obtained position detection result is correct, and outputs a set of the position identification information obtained as the position detection result and the reception feature quantity related to the mobile station as the position reception feature quantity to the position reception feature quantity learning unit 43. In such a manner, updating the by-area representative reception feature quantities recorded into the position reception feature quantity storage 44 by using the reception feature quantity as well obtained for the mobile station 1 makes it possible to reflect a reception feature quantity distribution within the area, which cannot be obtained by the reference station 2, into the by-area representative reception feature quantities recorded into the position reception feature quantity storage 44, and to realize the high precision of the position detection of the mobile station 1. Additionally, the position judging unit 45 preferably retrieves the reception feature quantity closest to the reception feature quantity related to the mobile station 1, which is inputted from the mobile station/reference station judging unit 42, from the by-area representative reception feature quantities recorded into the position reception feature quantity storage 44.

Herein, with regard to nearness between two reception feature quantities, the method can be employed of calculating a Euclidian distance between feature vectors and estimating that the two reception feature quantities are closer to each other as the Euclidian distance is smaller. Instead of the Euclidian distance, the distance based on an arbitrary calculation equation such as a city block distance can be also employed.

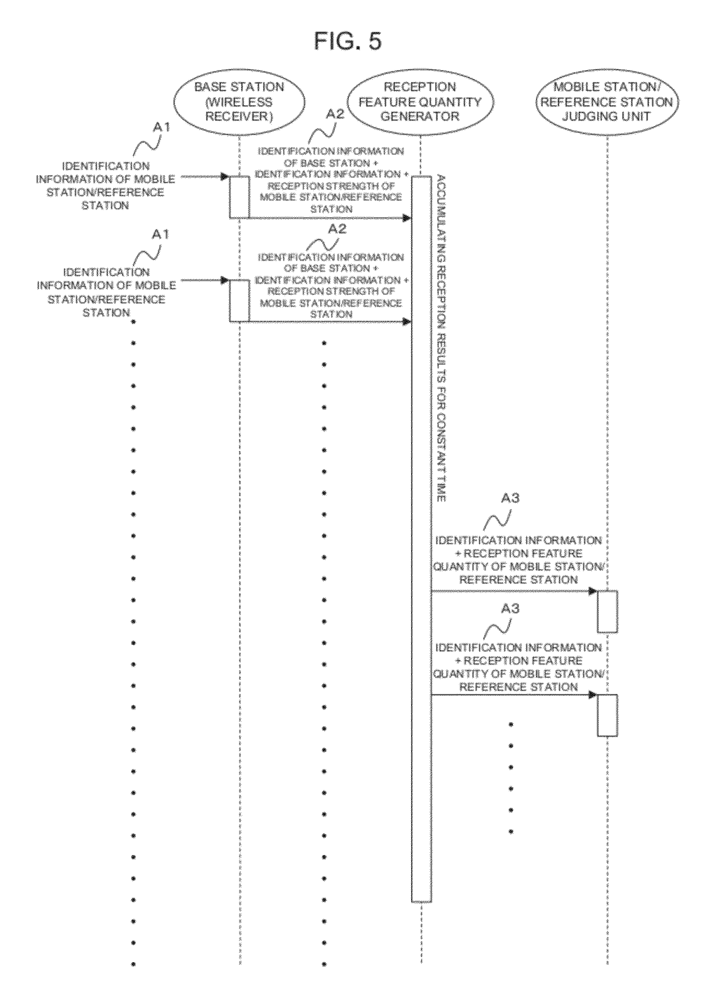

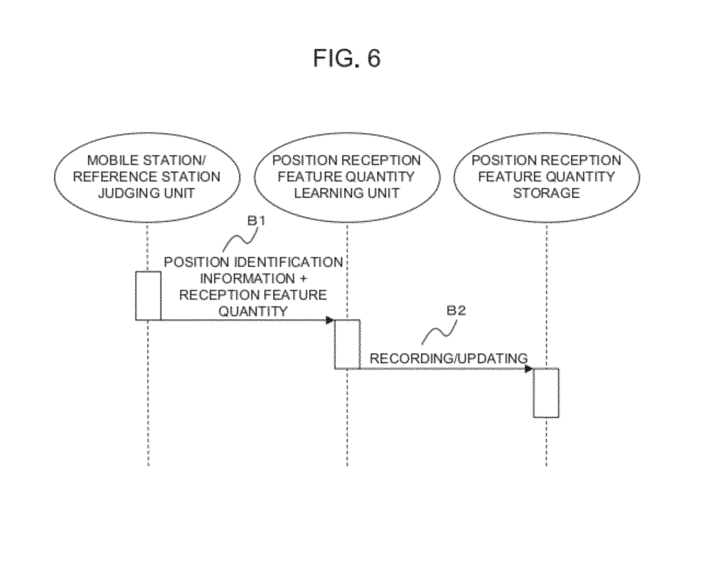

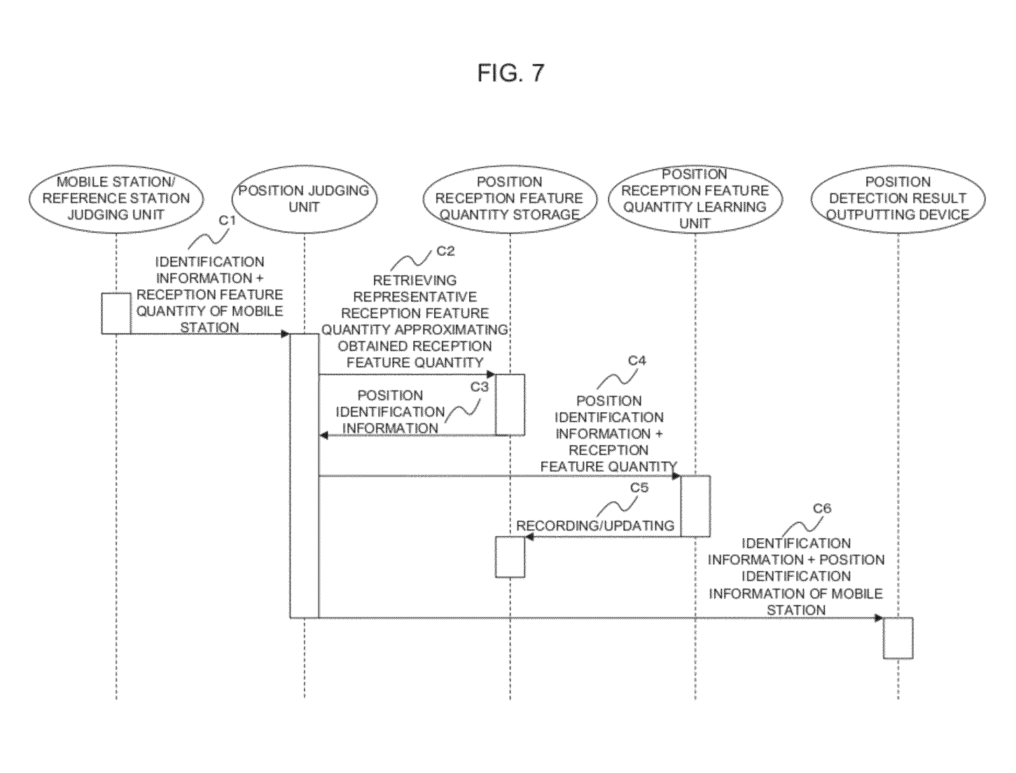

Next, an operation of the first exemplary embodiment of the present invention will be explained in details by referencing FIG. 2, FIG. 5, FIG. 6, and FIG. 7.

The base station 3 receives the identification information that the mobile station 1 and the reference station 2 transmit (step Al of FIG. 5), and outputs a set of the received identification information of the mobile station 1 or the reference station 2 and the reception strength together with identification information of the base station 3 to the reception feature quantity generator 41 (step A2 of FIG. 5). The reception feature quantity generator 41 accumulates the reception results of the mobile station 1 and the reference station 2 to be obtained from the base station 3 for a constant time, generates the reception feature quantity of each of the mobile station 1 and the reference station 2 from the accumulated reception results, and outputs it together with the corresponding identification information to the mobile station/reference station judging unit 42 (step A3 of FIG. 5).

The mobile station/reference station judging unit 42 outputs the reception feature quantity judged to be the reception feature quantity related to the reference station 2, out of the obtained reception feature quantities, together with the position identification information of the area in which the above reference station 2 has been installed to the position reception feature quantity learning unit 43 (step B1 of FIG. 6). The position reception feature quantity learning unit 43 records the obtained position reception feature quantity as the by-area representative reception feature quantity into the position reception feature quantity storage 44, or updates the by-area representative reception feature quantity recorded into the position reception feature quantity storage 44 based on the obtained position reception feature quantity (step B2 of FIG. 6).

Further, the mobile station/reference station judging unit 42 outputs the reception feature quantity judged to be the reception feature quantity related to the mobile station 1, out of the obtained reception feature quantities, together with the corresponding identification information to the position judging unit 45 (step C1 of FIG. 7). The position judging unit 45 retrieves the representative reception feature quantity approximating the reception feature quantity obtained for the mobile station 1 from the by-area representative reception feature quantities recorded into the position reception feature quantity storage 44 (step C2 of FIG. 7), and acquires the position identification information that corresponds to the retrieved representative reception feature quantity (step C3 of FIG. 7). The position judging unit 45 outputs the position identification information obtained for the mobile station 1 as the position detection result of the mobile station 1 (step C6 of FIG. 7), and outputs a set of the position identification information obtained as the position detection result and the reception feature quantity obtained for the mobile station 1 as the position reception feature quantity to the position reception feature quantity learning unit 43 (step C4 of FIG. 7). The position reception feature quantity learning unit 43 records the obtained position reception feature quantity as the by-area representative reception feature quantity into the position reception feature quantity storage 44, or updates the by-area representative reception feature quantity recorded into the position reception feature quantity storage 44 based on the obtained position reception feature quantity (step C5 of FIG. 7).

Next, an effect of the first exemplary embodiment of the present invention will be explained.

This exemplary embodiment updates the by-area reception feature quantities for judging the position by using the reception feature quantity as well that is obtained for the wireless machine attached to the mobile body in addition to the reception feature quantities that are obtained for the reference wireless machines even if there are few reference wireless machines installed in the environment, thereby making it possible to reflect a reception feature quantity distribution within the area, which cannot be obtained by the reference wireless machine, into the by-area representative reception feature quantities, and to realize the high precision of the position detection of the wireless machine attached to the mobile body.

### Second Exemplary Embodiment

Next, the second exemplary embodiment of the present invention will be explained in details by referencing the accompanied drawings.

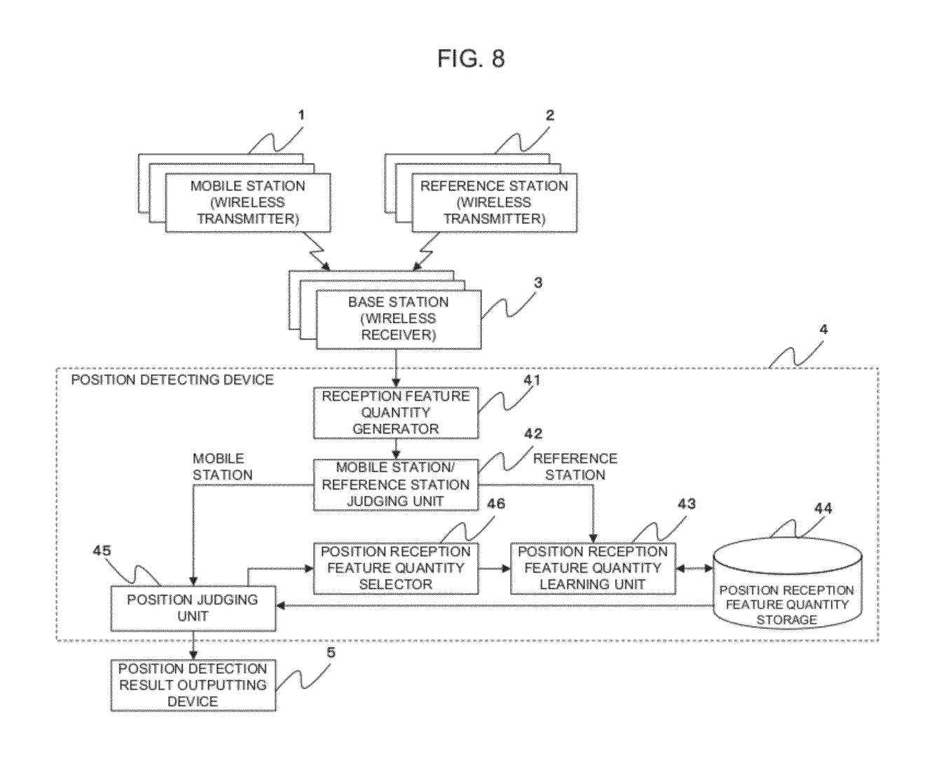

By referencing FIG. 8, the second exemplary embodiment of the present invention differs from the first exemplary embodiment of the present invention shown in FIG. 2 in a point that the position detection device 4 includes a position reception feature quantity selector 46.

The position reception feature quantity selector 46 judges whether to output the position reception feature quantity inputted from the position judging unit 45 to the position reception feature quantity learning unit 43, and outputs the above reception feature quantity to the position reception feature quantity learning unit 43 only when it has been judged that the reception feature quantity is outputted. Herein, the position reception feature quantity selector 46 outputs the inputted position reception feature quantity to the position reception feature quantity learning unit 43 only when the by-area representative reception feature quantity recorded into the position reception feature quantity storage 44 should be updated with the inputted reception feature quantity obtained for the mobile station 1.

As a specific example of the position reception feature quantity selector 46, the position reception feature quantities inputted from the position judging unit 45 are outputted to the position reception feature quantity learning unit 43 only when a value of a distance between the feature vector of the inputted reception feature quantity obtained for the mobile station 1 and that of the representative reception feature quantity recorded into the position reception feature quantity storage 44 correspondingly to the position identification information inputted from the position judging unit 45 is equal to or less than a threshold. Herein, as the distance between two feature vectors, the values calculated based on an arbitrary calculation equation such as the Euclidian distance between the feature vectors, the city block distance, and the values obtained by dividing these by an element number, respectively can be employed. Further, an appropriate value may be previously decided as the threshold of the distance between the feature vectors in some cases, or the threshold of the distance between the feature vectors may be automatically decided from among the by-area representative reception feature quantities in some cases. As a method of automatically deciding the threshold of the distance between the feature vectors from among the by-area representative reception feature quantities, there are, for example, the method of defining a half of the minimum value of the distance between representative reception feature quantities, out of all the sets of the area, as the threshold between the vectors, and the like.

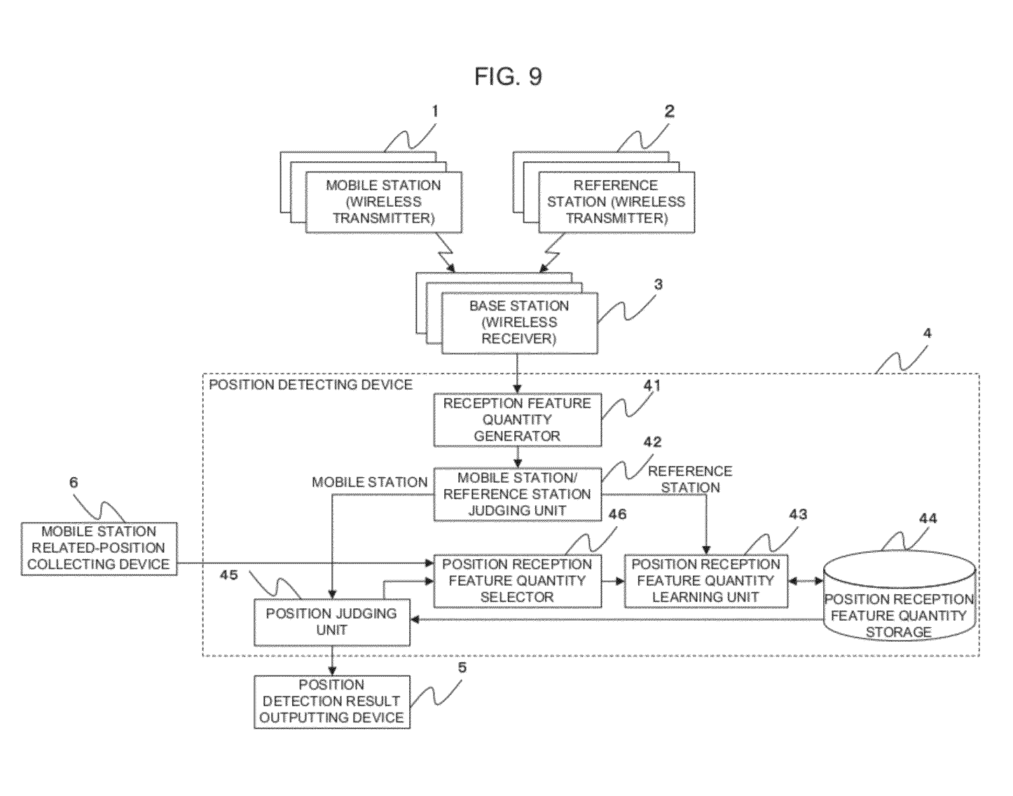

As another specific example of the position reception feature quantity selector 46, there is the example of judging a probability of the position identification information inputted from the position judging unit 45 according to the information inputted from a mobile station related-position collecting device 6 for collecting information related to the position of the mobile body having the mobile station as shown in FIG. 9, and outputting a set of the position identification information inputted from the position judging unit 45 and the reception feature quantity to the position reception feature quantity learning unit 43 only when it has been judged that the above position identification information is probable.

As an example of the mobile station related-position collecting device 6, there exists the device for acquiring the position of the mobile body having the mobile station 1 by employing a proximity-type wireless communication system by use of a touchless IC card system. In this case, the position of the mobile body obtained from the mobile station related-position collecting device 6 is regarded as the position of the mobile body acquired at a reliability higher than that of the position detection system of the present invention, and a set of the above position identification information and the reception feature quantity obtained for the mobile station 1 is outputted as the position reception feature quantity to the position reception feature quantity learning unit 43. Further, at this time, a set of the position identification information inputted from the position judging unit 45 and the reception feature quantity may be outputted to the position reception feature quantity learning unit 43 only when the position identification information obtained in the position judging unit 45 coincides with the position identification information obtained from the mobile station related-position collecting device 6.

As another example of the mobile station related-position collecting device 6, there exists the device for acquiring the position of the mobile body having the mobile station 1 from the system capable of acquiring the position of the mobile station by employing a GPS and a mobile telephone base station. In this case, the position of the mobile body obtained from the mobile station related-position collecting device 6 is regarded as the position of the mobile body acquired at a reliability higher than that of the position detection system of the present invention, and a set of the above position identification information and the reception feature quantity obtained for the mobile station 1 is outputted as the position reception feature quantity to the position reception feature quantity learning unit 43. Further, at this time, a configuration may be made in such a manner that it is judged whether the precision of the position information is sufficient based on a reliability index of the position information such as GDOP (geometric dilution of precision), HDOP (horizontal dilution of precision), and VDOP (vertical dilution of precision), which is obtained together with the position identification information from the mobile station related-position collecting device 6, the position of the mobile body obtained from the mobile station related-position collecting device 6 is regarded as the position of the mobile body acquired at a reliability higher than that of the position detection system of the present invention only when it has been judged that the precision of the position information is sufficient, and a set of the above position identification information and the reception feature quantity obtained for the mobile station 1 is outputted as the position reception feature quantity to the position reception feature quantity learning unit 43. Further, a set of the position identification information inputted from the position judging unit 45 and the reception feature quantity may be outputted to the position reception feature quantity learning unit 43 only when the position identification information obtained in the position judging unit 45 coincides with the position identification information obtained from the mobile station related-position collecting device 6.

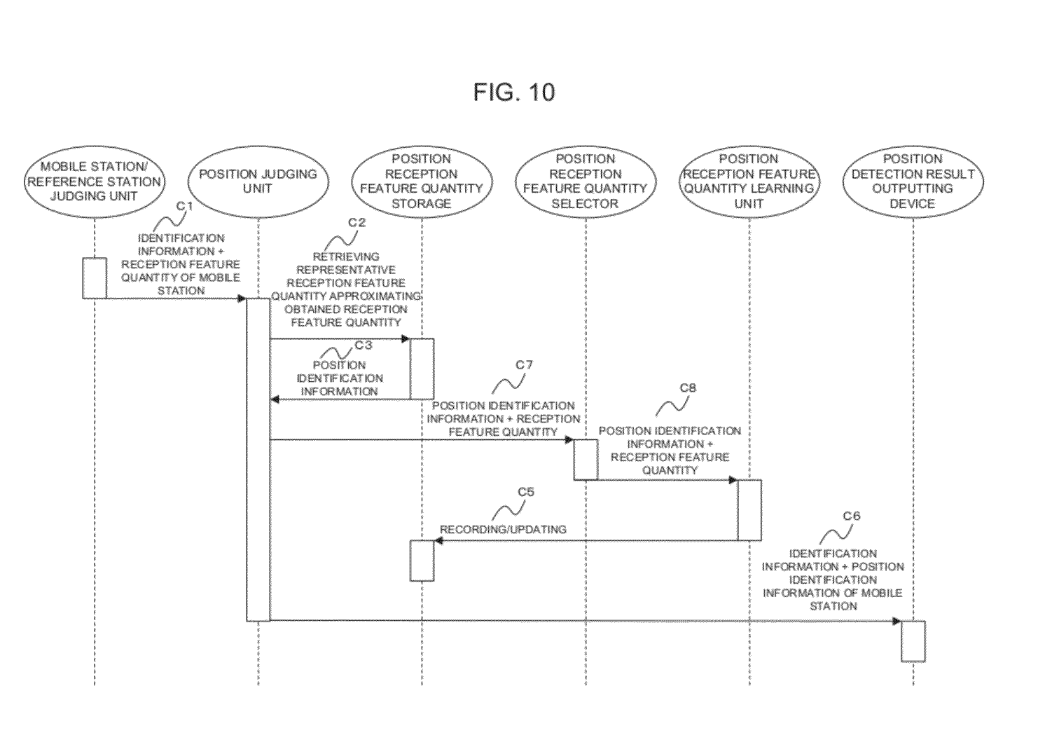

Next, an operation of the second exemplary embodiment of the present invention will be explained in details by referencing FIG. 8 and FIG. 10.

Operations of the mobile station 1, the reference station 2, the base station 3, the reception feature quantity generator 41, the mobile station/reference station judging unit 42, the position reception feature quantity learning unit 43, the position reception feature quantity storage 44, the position judging unit 45, and the position detection result outputting device 5 in this exemplary embodiment are identical to the operations of the mobile station 1, the reference station 2, the base station 3, the reception feature quantity generator 41, the mobile station/reference station judging unit 42, the position reception feature quantity learning unit 43, the position reception feature quantity storage 44, the position judging unit 45, and the position detection result outputting device 5 in the first exemplary embodiment, so its explanation is omitted.

The position judging unit 45 outputs the position identification information obtained for the mobile station as the position detection result of the mobile station 1 (step C6 of FIG. 10), and outputs a set of the position identification information obtained as the position detection result and the reception feature quantity obtained for the mobile station 1 as the position reception feature quantity to a position reception feature quantity selector 46 (step C7 of FIG. 10). The position reception feature quantity selector 46 judges whether to output the inputted position reception feature quantity to the position reception feature quantity learning unit 43, and outputs the inputted position reception feature quantity to the position reception feature quantity learning unit 43 only when it has been judged that the above position reception feature quantity is outputted (step C8 of FIG. 10). The position reception feature quantity learning unit 43 records the obtained position reception feature quantity as the by-area representative reception feature quantity into the position reception feature quantity storage 44, or updates the by-area representative reception feature quantity recorded into the position reception feature quantity storage 44 based on the obtained position reception feature quantity (step C5 of FIG. 10).

Continuously, an effect of the second exemplary embodiment of the present invention will be explained.

This exemplary embodiment, similarly to the first exemplary embodiment, updates the by-area reception feature quantities for judging the position by using the reception feature quantity as well that is obtained for the wireless machine attached to the mobile body in addition to the reception feature quantities that are obtained for the reference wireless machines even if there are few reference wireless machines installed in the environment, thereby making it possible to reflect a reception feature quantity distribution within the area, which cannot be obtained by the reference wireless machine, into the by-area representative reception feature quantities, and to realize the high precision of the position detection of the wireless machine attached to the mobile body.

In addition, besides this effect, updating the by-area representative reception feature quantity by employing the reception feature quantity having a high reliability of the position judgment, out of the reception feature quantities to be obtained for the wireless machine attached to the mobile body, makes it possible to make the precision of the position detection of the wireless machine attached to the mobile body higher.

### Third Exemplary Embodiment

Next, the third exemplary embodiment of the present invention will be explained in details by referencing the accompanied drawings.

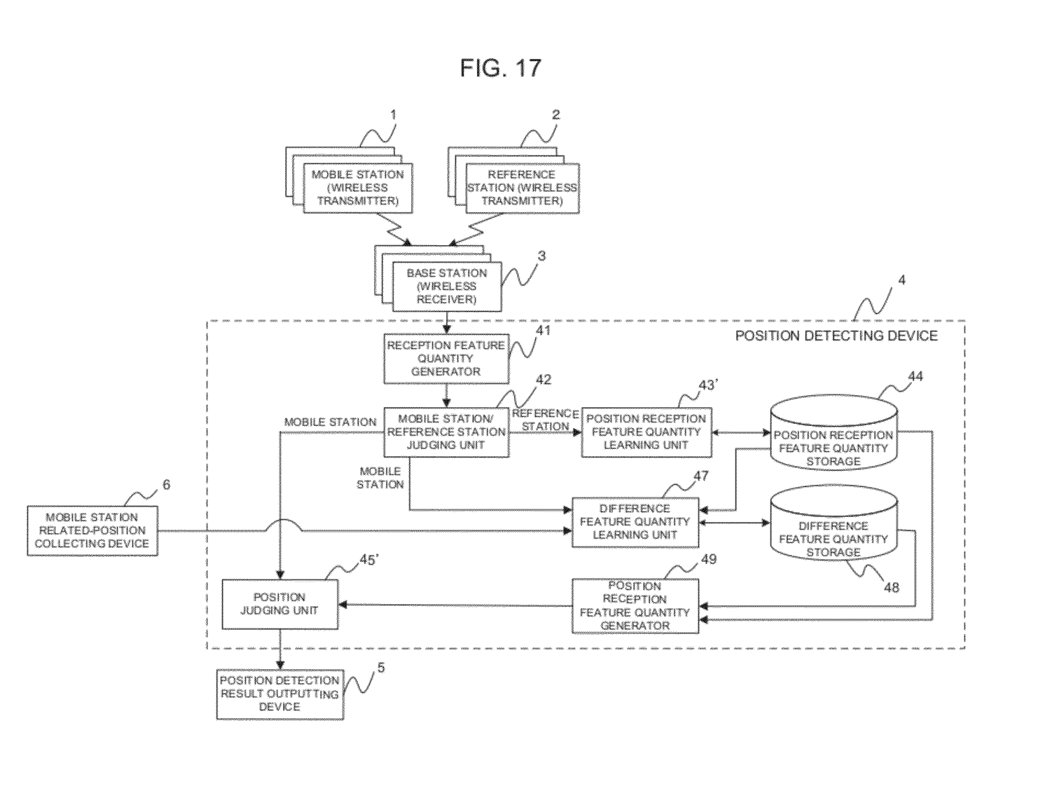

By referencing FIG. 17, the third exemplary embodiment of the present invention, as compared with the first exemplary embodiment of the present invention shown in FIG. 2, further includes a mobile station related-position collecting device 6. Further, the position detection device 4 includes a position reception feature quantity learning unit 43′ instead of the position reception feature quantity learning unit 43. The position reception feature quantity learning unit 43′ differs from the position reception feature quantity learning unit 43 of the first exemplary embodiment of the present invention in information to be inputted. Further, the position detection device 4 includes a position judging unit 45′ instead of the position judging unit 45. The position judging unit 45′ differs from the position judging unit 45 of the first exemplary embodiment of the present invention in information to be inputted and information to be outputted. In addition, the position detection device 4 includes a difference feature quantity learning unit 47, a difference feature quantity storage 48, and a position reception feature quantity generator reception feature quantity generator 49.

The mobile station related-position collecting device 6 is identical to the mobile station related-position collecting device 6 of the second exemplary embodiment of the present invention, so its explanation is omitted.

The position reception feature quantity learning unit 43′ learns the by-area reception feature quantities including a tendency of the past reception feature quantities that are inputted from the mobile station/reference station judging unit 42, and records them into the position reception feature quantity storage 44. A specific example of the position reception feature quantity learning unit 43′ is identical to the specific example of the position reception feature quantity learning unit 43 in the first exemplary embodiment of the present invention, so its explanation is omitted.

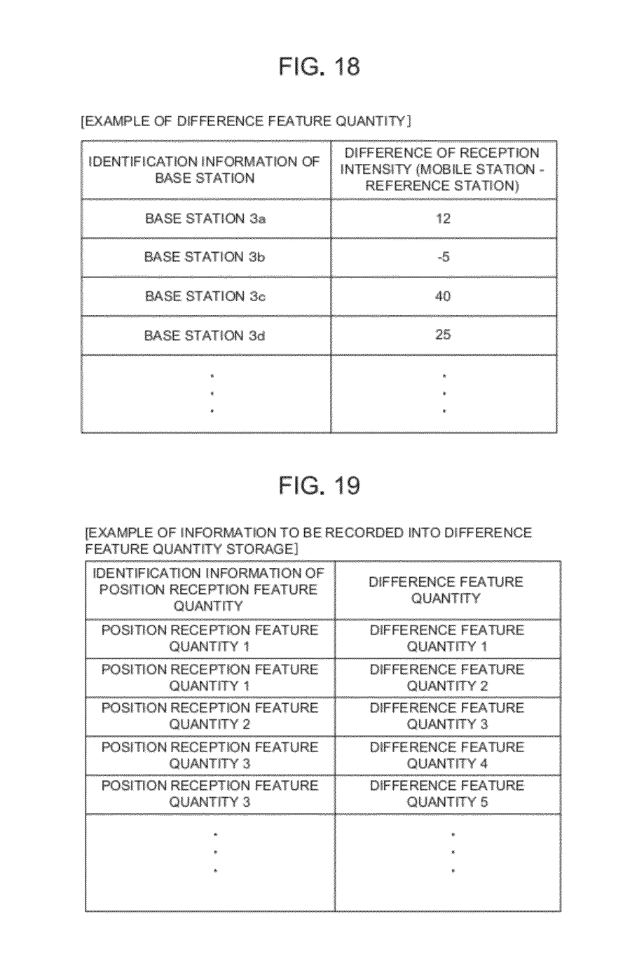

The difference feature quantity learning unit 47 receives the reception feature quantity obtained for the mobile station 1 from the mobile station/reference station judging unit 42. Further, the difference feature quantity learning unit 47 receives the position identification information of the mobile station 1 from the mobile station related-position collecting device 6. And, the difference feature quantity learning unit 47 retrieves the by-area reception feature quantities recorded into the position reception feature quantity storage 44 by employing the received position identification information. At this time, when a plurality of the reception feature quantities have been caused to correspond to the area, the difference feature quantity learning unit 47 retrieves the representative reception feature quantity. The difference feature quantity learning unit 47 acquires a difference feature quantity obtained by subtracting the retrieved reception feature quantity from the reception feature quantity received from the mobile station/reference station judging unit 42. And, the difference feature quantity learning unit 47 records the acquired difference feature quantity into the difference feature quantity storage 48. The difference feature quantity is expressed with the feature vector having, as a component, the reception strength obtained by subtracting the reception strength obtained for the reference station 2 from the reception strength obtained for the mobile station 1 for each of all the base stations 3. For example, the difference feature quantity, as shown in FIG. 18, behaves like (base station 3a, base station 3b, base station 3c, base station 3d, . . . )=(12, −5, 40, 25, . . . ). Further, one example of the content to be recorded into the difference feature quantity storage 48 is shown in FIG. 19. As shown in FIG. 19, the difference feature quantity together with the position reception feature quantity identification information for identifying the position reception feature quantity, being a partner with which the difference is calculated, is recorded into the difference feature quantity storage 48. The position reception feature quantity identification information is the identification information for uniquely identifying the reception feature quantity retrieved from the position reception feature quantity storage 44. Additionally, the calculated difference feature quantity may be recorded into the position reception feature quantity storage 44 correspondingly to the retrieved reception feature quantity.

The position reception feature quantity generatorreception feature quantity generator 49 calculates a sum of the difference feature quantity by each position reception feature quantity recorded into the difference feature quantity storage 48, and the corresponding position reception feature quantity recorded into the position reception feature quantity storage 44, thereby to generate the by-area representative reception feature quantity. And, the position reception feature quantity generatorreception feature quantity generator 49 outputs the representative reception feature quantity to the position judging unit 45′ responding to the retrieval from the position judging unit 45′.

The position judging unit 45′ retrieves the reception feature quantity approximating the reception feature quantity related to the mobile station 1, which is inputted from the mobile station/reference station judging unit 42, from the by-area representative reception feature quantities generated by the position reception feature quantity generatorreception feature quantity generator 49. And, the position judging unit 45′ outputs, as the position detection result, the position identification information corresponding to the retrieved representative reception feature quantity. Herein, with regard to nearness between two reception feature quantities, the method can be employed of calculating a Euclidian distance between feature vectors and estimating that the two reception feature quantities are closer to each other as the Euclidian distance is smaller. Instead of the Euclidian distance, the distance based on an arbitrary calculation equation such as a city block distance can be also employed.

Next, an operation of the third exemplary embodiment of the present invention will be explained in details by referencing FIG. 17 and FIG. 20 to FIG. 23. Operations of the mobile station 1, the reference station 2, the base station 3, the reception feature quantity generator 41, the mobile station/reference station judging unit 42, the position reception feature quantity storage 44, and the position detection result outputting device 5 in this exemplary embodiment are identical to the operations of the mobile station 1, the reference station 2, the base station 3, the reception feature quantity generator 41, the mobile station/reference station judging unit 42, the position reception feature quantity storage 44, and the position detection result outputting device 5 in the first exemplary embodiment, so its explanation is omitted. Further, an operation of the position reception feature quantity learning unit 43′ in this exemplary embodiment is identical to the operations of the position reception feature quantity learning unit 43 in the first exemplary embodiment of the present invention explained by employing FIG. 6, so its explanation is omitted.

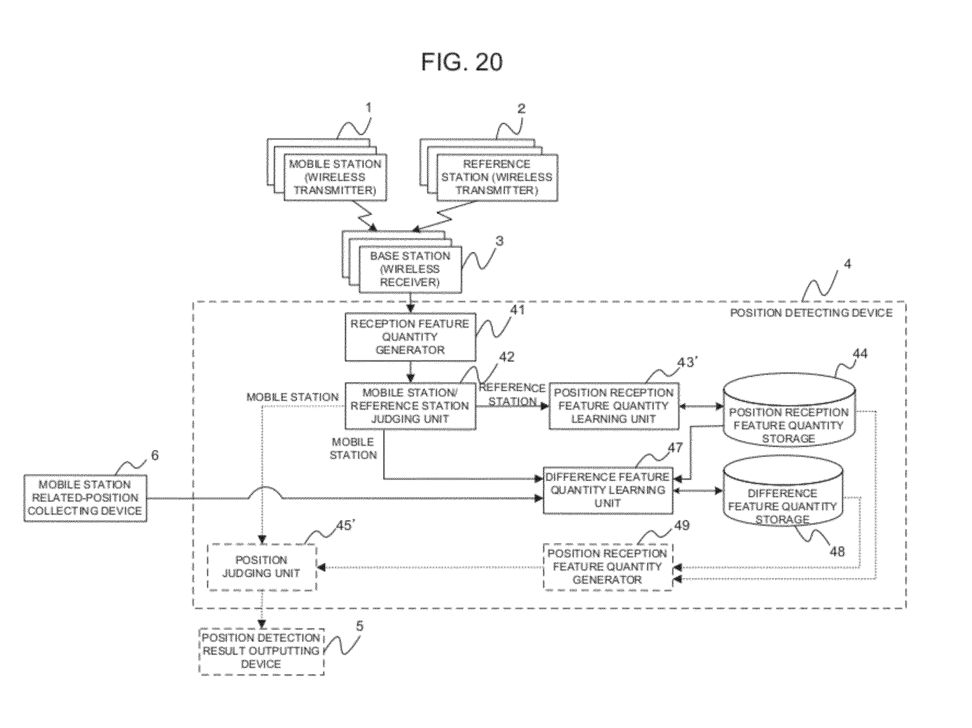

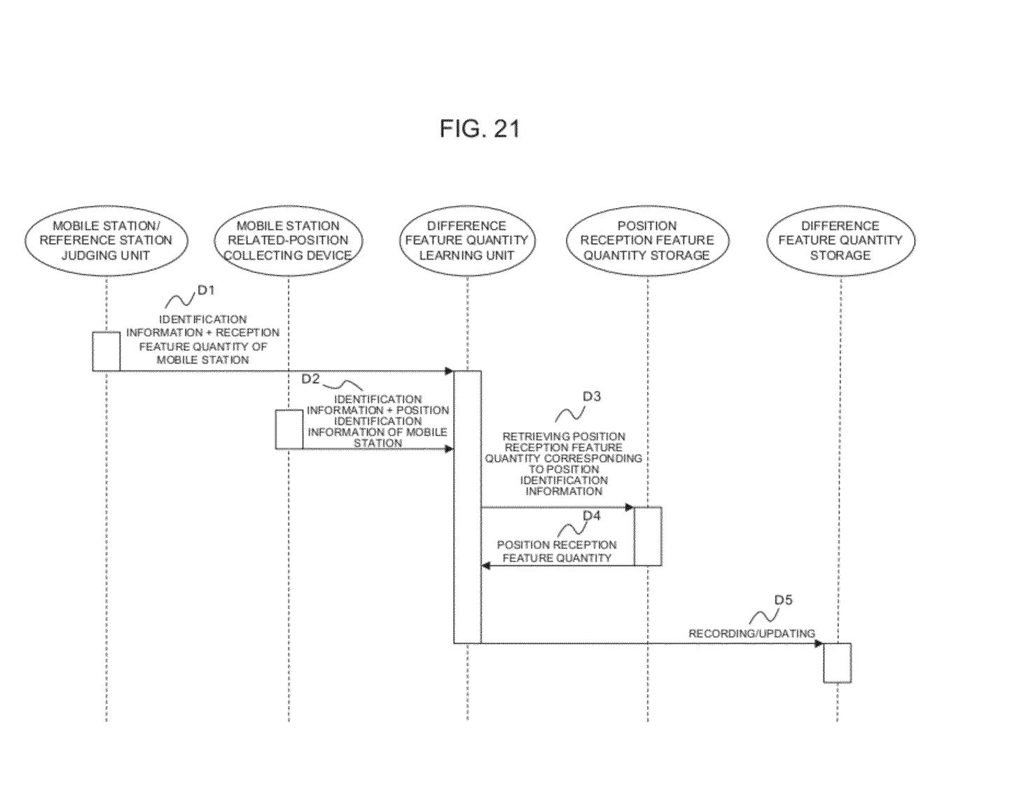

At first, an operation of generating the difference feature quantity from the reception feature quantity obtained for the mobile station 1, and the position identification information obtained for the mobile station 1 in the mobile station related-position collecting device 6, and recording it into the difference feature quantity storage 48, out of operations of the third exemplary embodiment of the present invention, will be explained in details by referencing FIG. 20 and FIG. 21. This operation is equivalent to an operation that is performed in order to pre-regulate (calibrate) this position detection device 4. That is, with this operation, the reception feature quantity is measured in a location in which the mobile station related-position collecting device 6 can acquire the position identification information by employing the mobile station 1 before performing the position detection using the position detection device 4, thereby allowing the position detection device 4 to be pre-regulated. However, the pre-regulation may be operated in such a manner that a set of the position identification information and the reception feature quantity is measured by employing not the mobile stations 1 but the reference stations 2, and one part of the reference stations 2 is withdrawn before performing the position detection using the position detection device 4.

The difference feature quantity learning unit 47 receives a set of mobile station identification information for identifying the mobile station 1 and the reception feature quantity from the mobile station/reference station judging unit (step D1). Further, the difference feature quantity learning unit 47 receives a set of mobile station identification information for identifying the mobile station 1 and position identification information indicating the position of the mobile station 1 from the mobile station related-position collecting device 6 (step D2).

The difference feature quantity learning unit 47 retrieves the position reception feature quantity corresponding to the position identification information inputted from the mobile station related-position collecting device 6 from the position reception feature quantity storage (step D3), and acquires the position reception feature quantity (step D4).

In addition, the difference feature quantity learning unit 47 calculates a difference between the acquired reception feature quantity related to the mobile station 1 and the acquired position reception feature quantity, generates the difference feature quantity, and records it together with the position reception feature quantity identification information into the difference feature quantity storage 48 (step D5).

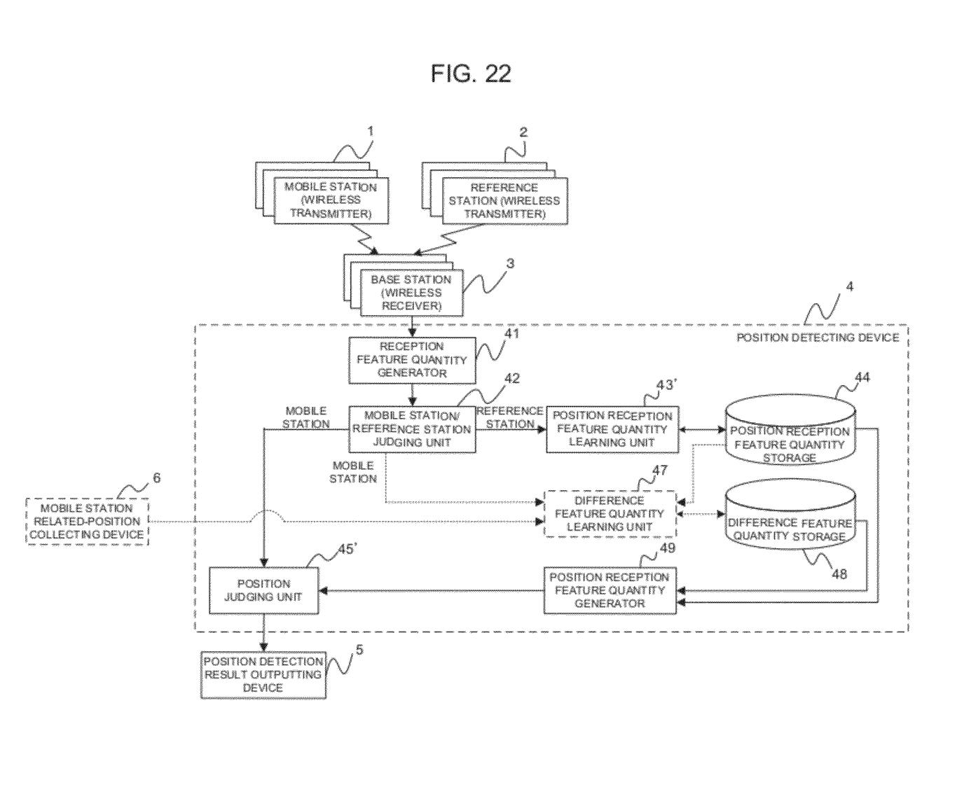

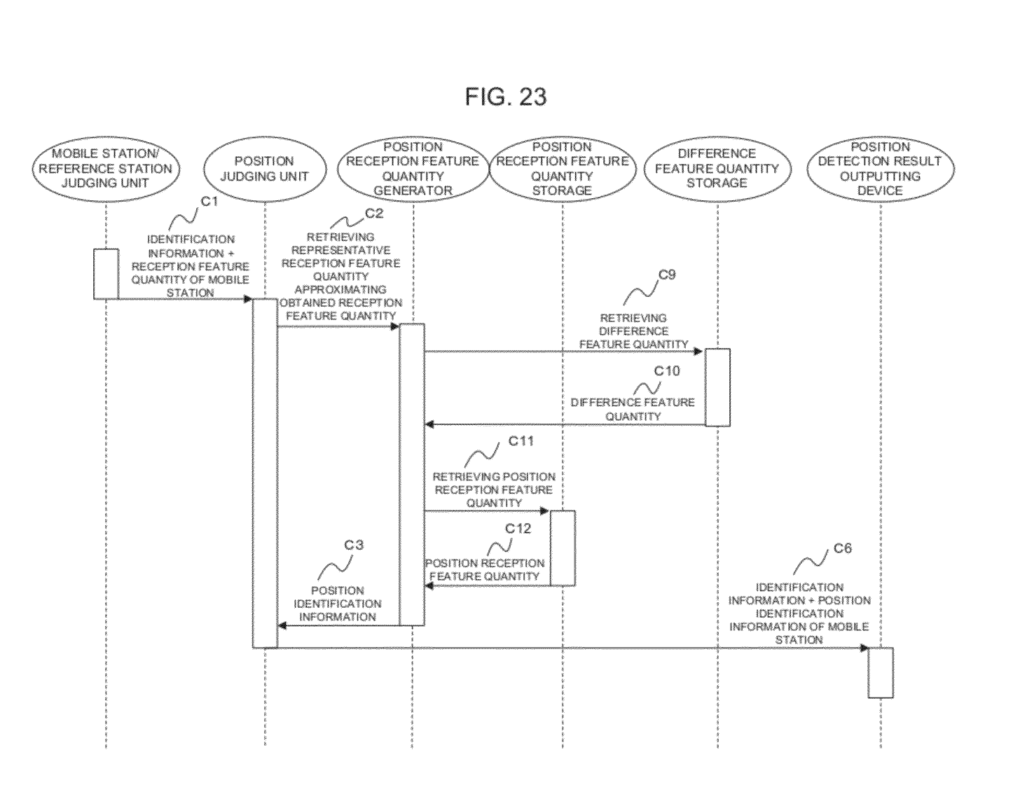

Next, an operation of acquiring the position identification information of the mobile station 1 from the reception feature quantity obtained for the mobile station 1, out of operations of the third exemplary embodiment of the present invention, will be explained in details by referencing FIG. 22 and FIG. 23. This operation is equivalent to an operation that is performed in order to detect the position of the mobile station 1 by employing this position detection device.

The position reception feature quantity generatorreception feature quantity generator 49 retrieves a set of the position reception feature quantity identification information and the difference feature quantity from the difference feature quantity storage 48 (step C9). The position reception feature quantity generatorreception feature quantity generator 49 acquires the difference feature quantity (step C10), retrieves the corresponding position reception feature quantity from the position reception feature quantity storage 44 (step C11) and acquires it (step C12).

In addition, the position reception feature quantity generatorreception feature quantity generator 49 calculates a sum of the acquired difference feature quantity and the corresponding position reception feature quantity, and newly generates the by-area representative reception feature quantity.

The position judging unit 45′ retrieves the representative reception feature quantity approximating the reception feature quantity obtained for the mobile station 1 (step C1), which has been inputted from the mobile station/reference station judging unit, from the by-area representative reception feature quantities generated by the position reception feature quantity generatorreception feature quantity generator 49 (step C2). And, the position judging unit 45′ acquires the position identification information corresponding to the retrieved representative reception feature quantity (step C3), and outputs the position identification information obtained for the mobile station 1 as the position detection result of the mobile station 1 to the position detection result outputting device 5 (step C6).

Continuously, an effect of the third exemplary embodiment of the present invention will be explained.

This exemplary embodiment, similarly to the first exemplary embodiment, generates the by-area reception feature quantities for judging the position by using the ground-truthed reception feature quantity as well that is obtained when pre-regulating (calibrating) the position detection device using the wireless machine attached to the mobile body in addition to the reception feature quantities that are obtained for the reference wireless machines even if there are few reference wireless machines installed in the environment, thereby making it possible to reflect a reception feature quantity distribution within the area, which cannot be obtained only by the reference wireless machine, into the by-area representative reception feature quantities, and to realize the high precision of the position detection of the wireless machine attached to the mobile body.

### Fourth Exemplary Embodiment>

Next, the fourth exemplary embodiment of the present invention will be explained in details by referencing the accompanied drawings.

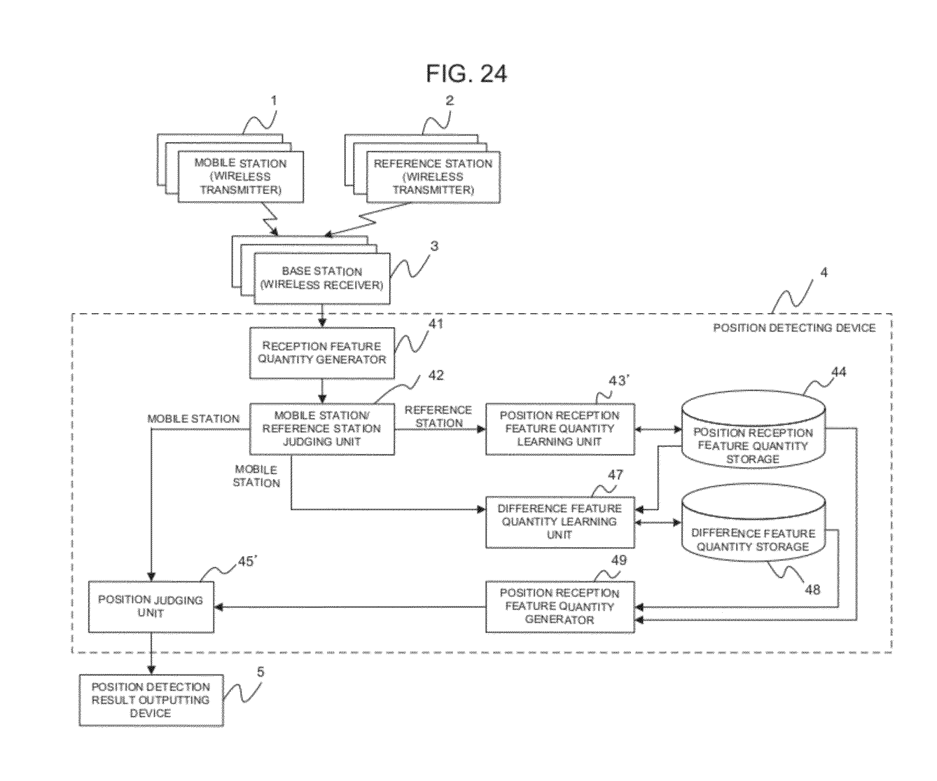

By referencing FIG. 24, in the fourth exemplary embodiment of the present invention, as compared with the first exemplary embodiment of the present invention shown in FIG. 2, the position detection device 4 includes a position reception feature quantity learning unit 43′ instead of the position reception feature quantity learning unit 43. The position reception feature quantity learning unit 43′ differs from the position reception feature quantity learning unit 43 of the first exemplary embodiment of the present invention in information to be inputted. Further, the position detection device 4 includes a position judging unit 45″ instead of the position judging unit 45. The position judging unit 45″ differs from the position judging unit 45 of the first exemplary embodiment of the present invention in information to be inputted.

In addition, the fourth exemplary embodiment differs in a point that the position detection device 4 includes a difference feature quantity learning unit 47, a difference feature quantity storage 48, and a position reception feature quantity generatorreception feature quantity generator 49.

The position reception feature quantity learning unit 43′, the position reception feature quantity storage 44, the difference feature quantity learning unit 47, the difference feature quantity storage 48, and the position reception feature quantity generatorreception feature quantity generator 49 are identical to the position reception feature quantity learning unit 43′, the position reception feature quantity storage 44, the difference feature quantity learning unit 47, the difference feature quantity storage 48, and the position reception feature quantity generatorreception feature quantity generator 49 in the third exemplary of the present invention, so its explanation is omitted.

The position judging unit 45″ retrieves the reception feature quantity approximating the reception feature quantity related to the mobile station 1, which is inputted from the mobile station/reference station judging unit 42, from the by-area representative reception feature quantities generated by the position reception feature quantity generatorreception feature quantity generator 49, and outputs the position identification information corresponding to the retrieved representative reception feature quantity as the position detection result. In addition, at this time, the position judging unit 45″ assumes that the obtained position detection result is correct, and outputs a set of the position identification information obtained as the position detection result and the reception feature quantity related to the mobile station 1 as the position reception feature quantity to the difference feature quantity learning unit 47. In such a manner, recording the difference feature quantity into the difference feature quantity storage 48 by using the reception feature quantity as well obtained for the mobile station 1 makes it possible to record a reception feature quantity distribution within the area, which cannot be obtained only by the reference station 2, into the difference feature quantity storage 48, and to realize the high precision of the position detection of the mobile station 1.

Herein, with regard to nearness between two reception feature quantities, the method can be employed of calculating a Euclidian distance between feature vectors and estimating that the two reception feature quantities are closer to each other as the Euclidian distance is smaller. Instead of the Euclidian distance, the distance based on an arbitrary calculation equation such as a city block distance can be also employed.

Next, an operation of the fourth exemplary embodiment of the present invention will be explained in details.

Operations of the mobile station 1, the reference station 2, the base station 3, the reception feature quantity generator 41, the mobile station/reference station judging unit 42, the position reception feature quantity storage 44, and the position detection result outputting device 5 in this exemplary embodiment are identical to the operations of the mobile station 1, the reference station 2, the base station 3, the reception feature quantity generator 41, the mobile station/reference station judging unit 42, the position reception feature quantity storage 44, and the position detection result outputting device 5 in the first exemplary embodiment of the present invention, so its explanation is omitted. Further, operations of the position reception feature quantity learning unit 43′, the difference feature quantity learning unit 47, the difference feature quantity storage 48, and the position reception feature quantity generatorreception feature quantity generator 49 in this exemplary embodiment are identical to the operations of the position reception feature quantity learning unit 43′, the difference feature quantity learning unit 47, the difference feature quantity storage 48, and the position reception feature quantity generatorreception feature quantity generator 49 in the third exemplary embodiment of the present invention, so its explanation is omitted. Further, an operation of the position judging unit 45″ in this exemplary embodiment is identical to the operation of the position judging unit 45′ in the third exemplary embodiment of the present invention explained by employing FIG. 23, so its explanation is omitted.

Next, an effect of the fourth exemplary embodiment of the present invention will be explained.

This exemplary embodiment generates the by-area reception feature quantities for judging the position by using the reception feature quantity as well that is obtained for the wireless machine attached to the mobile body in addition to the reception feature quantities to be obtained for the reference wireless machines even if there are few reference wireless machines installed in the environment, thereby making it possible to reflect a reception feature quantity distribution within the area, which cannot be obtained only by the reference wireless machine, into the by-area representative reception feature quantities, and to realize the high precision of the position detection of the wireless machine attached to the mobile body.

### Fifth Exemplary Embodiment

Next, the fifth exemplary embodiment of the present invention will be explained in details by referencing the accompanied drawings.

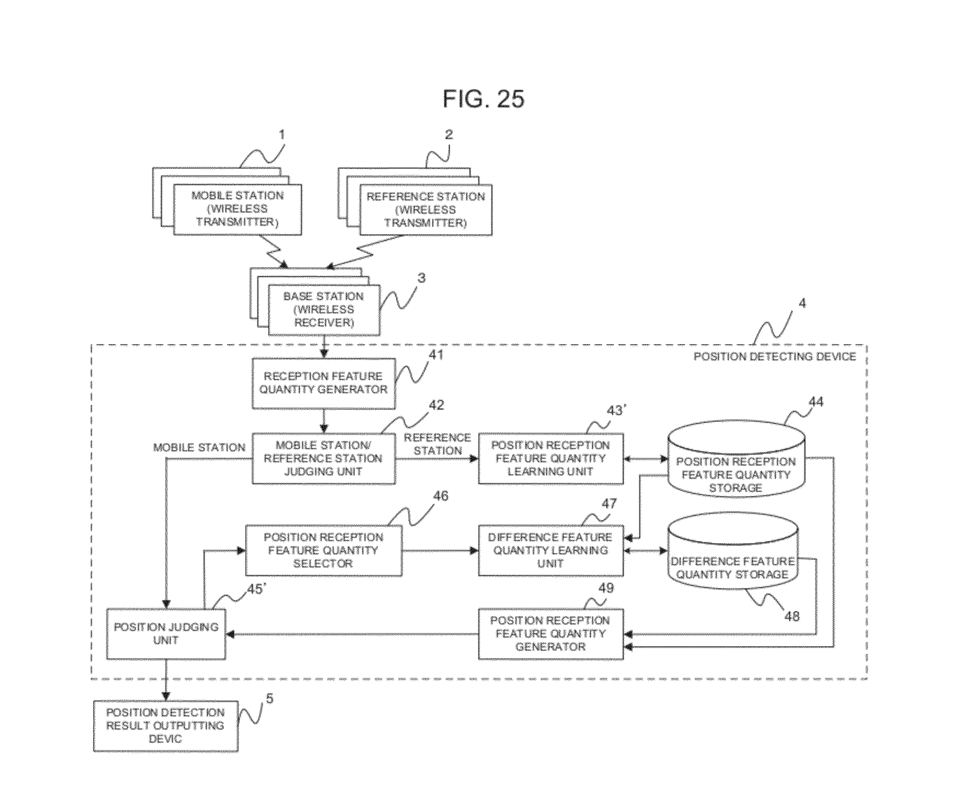

By referencing FIG. 25, the fifth exemplary embodiment of the present invention differs from the fourth exemplary embodiment of the present invention shown in FIG. 24 in a point that the position detection device 4 includes a position reception feature quantity selector 46.

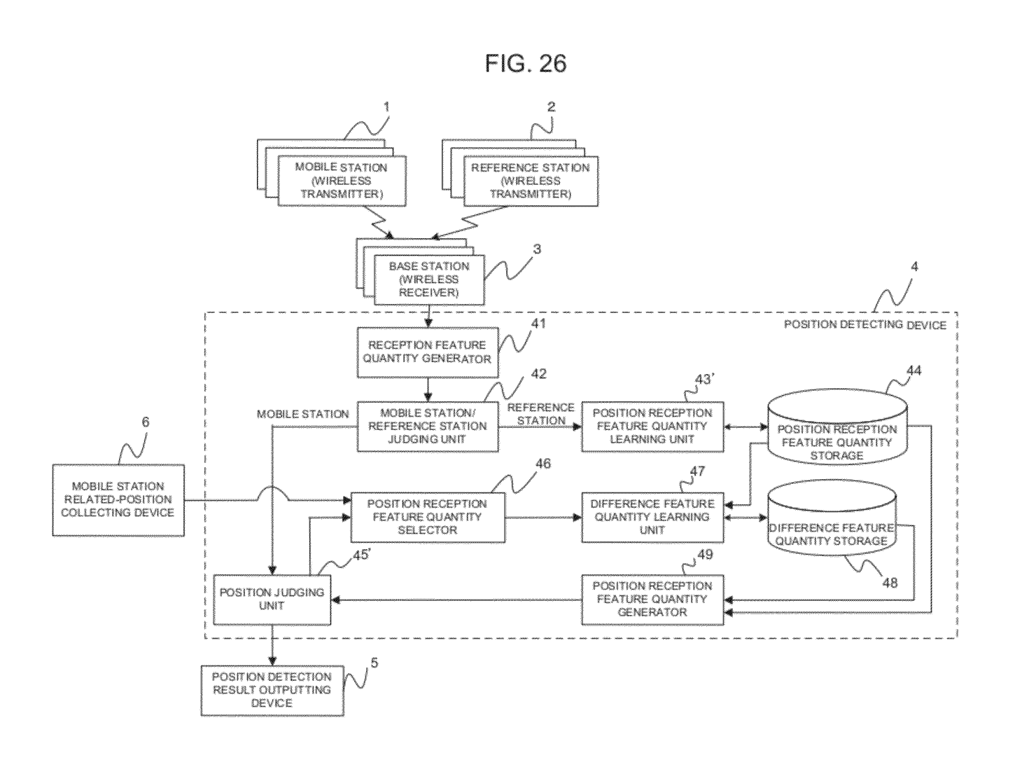

The position reception feature quantity selector 46 is identical to the position reception feature quantity selector 46 in the second exemplary embodiment of the present invention, so its explanation is omitted. Further, as shown in FIG. 26, the position reception feature quantity selector 46, similarly to the position reception feature quantity selector 46 in the second exemplary embodiment of the present invention, may judge a probability of the position identification inputted from the position judging unit 45″ according to the information to be inputted from the mobile station related-position collecting device 6 to output a set of the position identification information inputted from the position judging unit 45″ and the reception feature quantity to the difference feature quantity learning unit 47 only when it has been judged that it is probable.

Next, an operation of the fifth exemplary embodiment of the present invention will be explained in details.

Operations of the mobile station 1, the reference station 2, the base station 3, the reception feature quantity generator 41, the mobile station/reference station judging unit 42, the position reception feature quantity learning unit 43′, the position reception feature quantity storage 44, the difference feature quantity learning unit 47, the difference feature quantity storage 48, the position reception feature quantity generatorreception feature quantity generator 49, the position judging unit 45″, and the position detection result outputting device 5 in this exemplary embodiment are identical to the operations of the mobile station 1, the reference station 2, the base station 3, the reception feature quantity generator 41, the mobile station/reference station judging unit 42, the position reception feature quantity learning unit 43′, the position reception feature quantity storage 44, the difference feature quantity learning unit 47, the difference feature quantity storage 48, the position reception feature quantity generatorreception feature quantity generator 49, the position judging unit 45″, and the position detection result outputting device 5 in the fourth exemplary embodiment of the present invention, respectively, so its explanation is omitted. Further, an operation of the position reception feature quantity selector 46 in this exemplary embodiment is identical to the operation of the position reception feature quantity selector 46 in the second exemplary embodiment of the present invention explained by employing FIG. 8 and FIG. 10, so its explanation is omitted.

Next, an effect of the fifth exemplary embodiment of the present invention will be explained.

This exemplary embodiment, similarly to the fourth exemplary embodiment, generates the by-area reception feature quantities for judging the position by using the reception feature quantity as well that is obtained for the wireless machine attached to the mobile body in addition to the reception feature quantities to be obtained for the reference wireless machines even if there are few reference wireless machines installed in the environment, thereby making it possible to reflect a reception feature quantity distribution within the area, which cannot be obtained only by the reference wireless machine, into the by-area representative reception feature quantities, and to realize the high precision of the position detection of the wireless machine attached to the mobile body.

In addition, besides this effect, generating the by-area reception feature quantity for judging the position by using the reception feature quantity having a high reliability of the position judgment, out of the reception feature quantities to be obtained for the wireless machine attached to the mobile body, makes it possible to make the precision of the position detection of the wireless machine attached to the mobile body higher.

### Sixth Exemplary Embodiment>

Next, the sixth exemplary embodiment of the present invention will be explained in details by referencing the accompanied drawings.

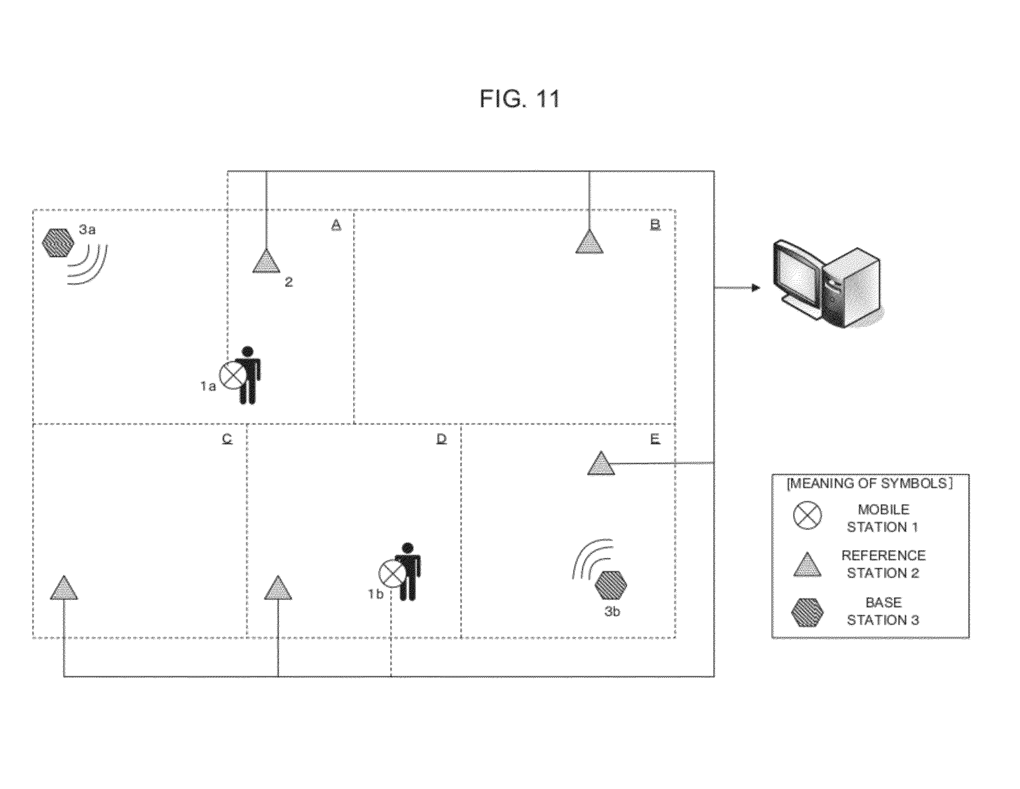

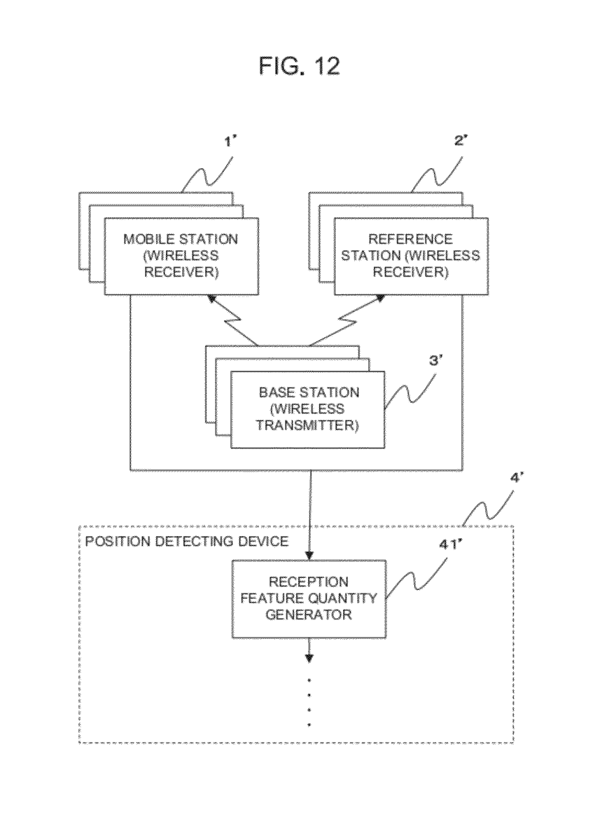

By referencing FIG. 11 and FIG. 12, the sixth exemplary embodiment of the present invention, as compared with the first exemplary embodiment of the present invention shown in FIG. 1 and FIG. 2, includes a base station 3′ instead of the base station 3, a mobile station 1′ instead of the mobile station 1, and a reference station 2′ instead of the reference station 2. While the base station 3 was the wireless receiver in the first exemplary embodiment, the base station 3′, which is installed in the environment, transmits the identification information for identifying the device every constant time interval by use of the wireless communication. While the mobile station 1 was the wireless transmitter in the first exemplary embodiment, the mobile station 1′, which is attached to the detection target such as the mobile body, receives the identification information to be transmitted by the base station 3′ by use of the wireless communication. While the reference station 2 was the wireless transmitter in the first exemplary embodiment, the reference station 2′, which is installed in the environment correspondingly to the pre-defined area, receives the identification information to be transmitted by the base station 3′ by use of the wireless communication. Further, the position detection device 4′ of this exemplary embodiment generates the reception feature quantity of the mobile station 1′ from the reception result of the base station 3′ obtained by the mobile station 1′, and generates the reception feature quantity of the reference station 2′ from the reception result of the base station 3′ obtained by the reference station 2′ instead of the reception feature quantity generator 41 in a configuration of the position detection device 4 of the first exemplary embodiment. And, the position detection device 4′ outputs respective generated reception feature quantities together with the corresponding identification information. Further, this exemplary embodiment, similarly to the first exemplary embodiment, is configured differently from the second exemplary embodiment shown in FIG. 9, the third exemplary embodiment shown in FIG. 17, the fourth exemplary embodiment shown in FIG. 24, and the fifth exemplary embodiment shown in FIG. 25, respectively. The reception feature quantity generated by the mobile station 1′ or the reference station 2′ may be transmitted to the position detection device 4′ with the wireless in some cases, or with the wire in some cases.

However, the mobile station l′ and the reference station 2′ receive the identification information to be transmitted by the base station 3′, and measure the reception strength. The mobile station 1′ and the reference station 2′ outputs a set of the acquired identification information of the base station and the reception strength as the reception result together with the identification information of the mobile station 1′ or the reference station 2′ to the reception feature quantity generator 41′.

Additionally, at least one reference station 2′ or more needs to be installed for each pre-defined area. Further, the base stations 3′ do not always need to be installed in a plural number, and the base stations 3′ could be single.

In addition, the base station 3′ does not always need to transmit the identification information every constant time interval, and for example, may dynamically change the time interval at which the identification information is transmitted responding to a time zone, a movement speed of the mobile body, and the like in some cases, or may transmit the identification information when receiving an instruction coming from a user, being the mobile body, the position detection device, and the like in some cases.

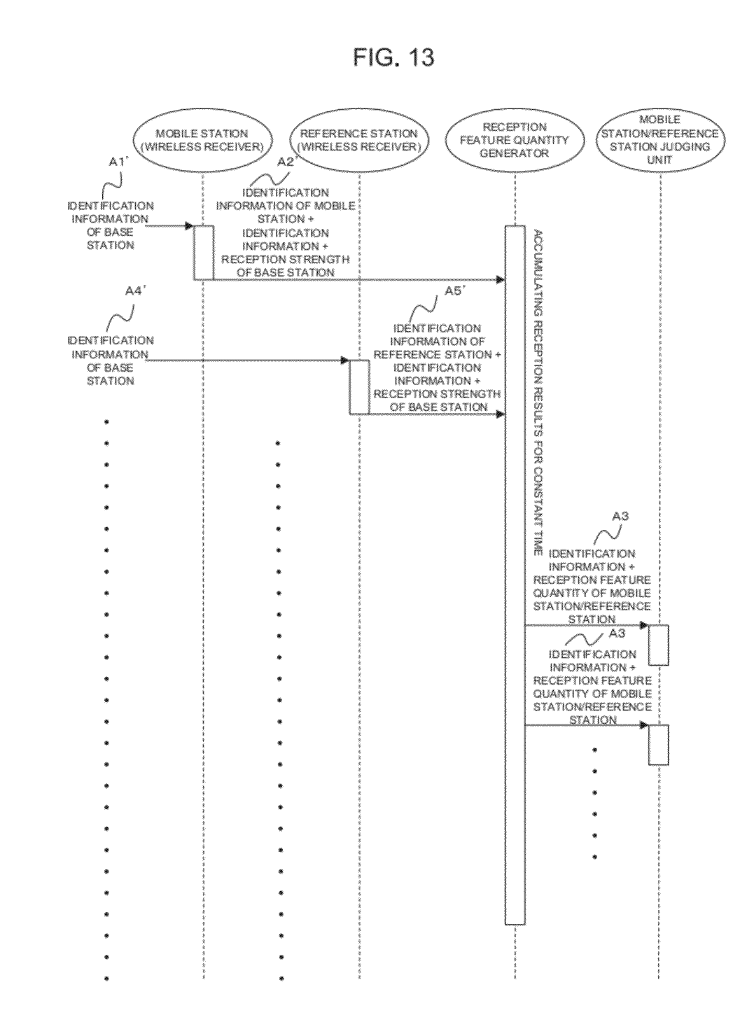

Next, an operation of the sixth exemplary embodiment of the present invention will be explained in details by referencing FIG. 12 and FIG. 13.

An operation subsequent to the operation of the reception feature quantity generator 41′ of the position detection device 4′ in the sixth exemplary embodiment of the present invention is identical to the operation subsequent to the operation of the reception feature quantity generator 41 of the position detection device 4 in the first, the second, the third, the fourth or the fifth exemplary embodiment, so its explanation is omitted.

The mobile station 1′ and the reference station 2′ receive the identification information to be transmitted by the base station 3′ (step A1' and step A4′ of FIG. 13), and outputs a set of the received identification information of the base station 3′ and the reception strength together with the identification information of the mobile station 1′ and the reference station 2′ to the reception feature quantity generator 41′, respectively, (step A2′ and step A5′ of FIG. 13). The reception feature quantity generator 41′ accumulates the reception results of the base station 3′ to be obtained from the mobile station 1′ and the reference station 2′ for a constant time, generates the reception feature quantity of each of the mobile station 1′ and the reference station 2′ from the accumulated reception results, and outputs it together with the corresponding identification information to the mobile station/reference station judging unit 42 (step A3 of FIG. 13).

Next, an effect of the sixth exemplary embodiment of the present invention will be explained.

This exemplary embodiment updates the by-area reception feature quantities for judging the position by using the reception feature quantity as well that is obtained for the wireless machine attached to the mobile body in addition to the reception feature quantities to be obtained for the reference wireless machines even if there are few reference wireless machines installed in the environment, thereby making it possible to reflect a reception feature quantity distribution within the area, which cannot be obtained by the reference wireless machine, into the by-area representative reception feature quantities, and to realize the high precision of the position detection of the wireless machine attached to the mobile body.

In addition, besides this effect, updating the by-area representative reception feature quantity by using the reception feature quantity having a high reliability of the position judgment, out of the reception feature quantities to be obtained for the wireless machine attached to the mobile body, makes it possible to make the precision of the position detection of the wireless machine attached to the mobile body higher.

### Seventh Exemplary Embodiment

Next, the seventh exemplary embodiment of the present invention will be explained in details by referencing the accompanied drawings.

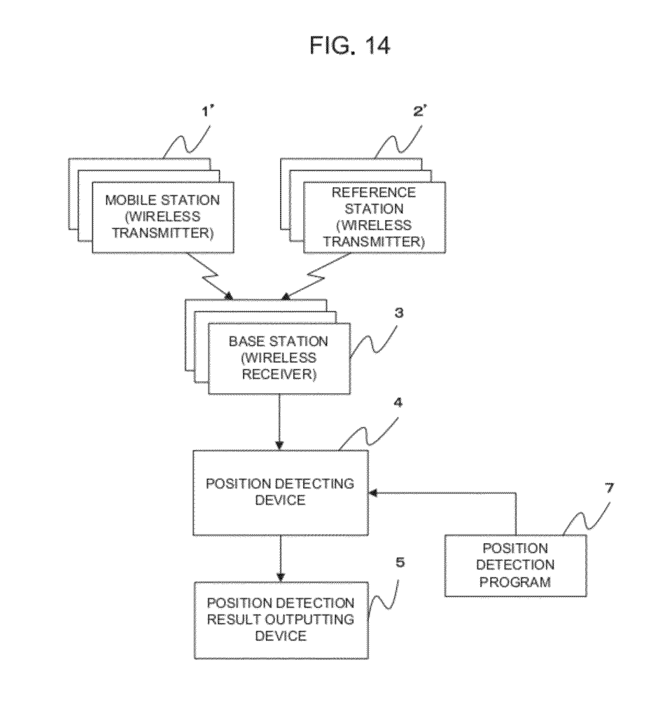

By referencing FIG. 14, the seventh exemplary embodiment of the present invention, similarly to the first, the second, the third, the fourth, and the fifth exemplary embodiments of the present invention, includes a mobile station 1 for transmitting the identification information for identifying the device every constant time interval by use of the wireless communication, which is installed in the detection target such as the mobile body, a reference station 2 for transmitting the identification information for identifying the device every constant time interval by use of the wireless communication, which is installed in the environment correspondingly to the pre-defined area, a base station 3 for receiving, by use of the wireless communication, the identification information to be transmitted by the mobile station 1 and the reference station 2, which is installed in the environment, a position detection device 4 for detecting the area in which the mobile station 1 exists by employing the reception result of the mobile station 1 and the reference station 2 obtained by the base station 3, and a position detection result outputting device 5 for outputting the position detection result.

A position detection program 7, which is loaded into the position detection device 4, controls an operation of the position detection device 4. With the control by the position detection program 7, the position detection device 4 executes a process identical to the process by the position detection device 4 in the first, the second, the third, the fourth, or the fifth exemplary embodiments of the present invention.

Next, an effect of the seventh exemplary embodiment of the present invention will be explained.

This exemplary embodiment updates the by-area reception feature quantities for judging the position by using the reception feature quantity as well that is obtained for the wireless machine attached to the mobile body in addition to the reception feature quantities to be obtained for the reference wireless machines even if there are few reference wireless machines installed in the environment, thereby making it possible to reflect a reception feature quantity distribution within the area, which cannot be obtained by the reference wireless machine, into the by-area representative reception feature quantities, and to realize the high precision of the position detection of the wireless machine attached to the mobile body.

In addition, besides this effect, updating the by-area representative reception feature quantity by using the reception feature quantity having a high reliability of the position judgment, out of the reception feature quantities to be obtained for the wireless machine attached to the mobile body, makes it possible to make the precision of the position detection of the wireless machine attached to the mobile body higher.

### Eighth Exemplary Embodiment

Next, the eighth exemplary embodiment of the present invention will be explained in details by referencing the accompanied drawings.

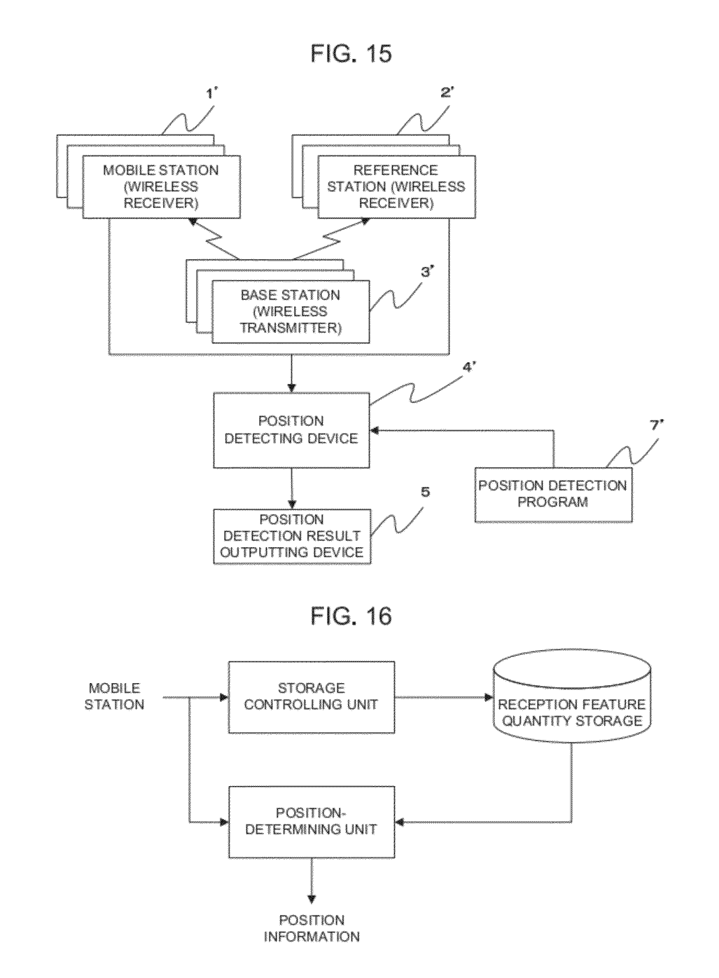

By referencing FIG. 15, the eighth exemplary embodiment of the present invention, similarly to the sixth exemplary embodiment of the present invention, includes a base station 3′ for transmitting the identification information for identifying the device every constant time interval by use of the wireless communication, which is installed in the environment, a mobile station 1′ for receiving, by use of the wireless communication, the identification information to be transmitted by the base station 3′, which is installed in the detection target such as the mobile body, a reference station 2′ for receiving, by use of the wireless communication, the identification information to be transmitted by the base station 3′, which is installed in the environment correspondingly to the pre-defined area, a position detection device 4′ for detecting the area in which the mobile station 1′ exists by employing the reception result of the base station 3′ obtained by the mobile station 1′ and the reference station 2′, and a position detection result outputting device 5 for outputting the position detection result.

A position detection program 7′, which is loaded into the position detection device 4′, controls an operation of the position detection device 4′. With the control by the position detection program 7′, the position detection device 4′ executes a process identical to the process by the position detection device 4′ in the sixth exemplary embodiment of the present invention.

Next, an effect of the eighth exemplary embodiment of the present invention will be explained.

This exemplary embodiment updates the by-area reception feature quantities for judging the position by using the reception feature quantity as well that is obtained for the wireless machine attached to the mobile body in addition to the reception feature quantities to be obtained for the reference wireless machines even if there are few reference wireless machines installed in the environment, thereby making it possible to reflect a reception feature quantity distribution within the area, which cannot be obtained by the reference wireless machine, into the by-area representative reception feature quantities, and to realize the high precision of the position detection of the wireless machine attached to the mobile body.

In addition, besides this effect, updating the by-area representative reception feature quantity by using the reception feature quantity having a high reliability of the position judgment, out of the reception feature quantities to be obtained for the wireless machine attached to the mobile body, makes it possible to make the precision of the position detection of the wireless machine attached to the mobile body higher.

### EXAMPLE 1

Next, the example 1 of the present invention will be explained. Such an example corresponds to the first, the second, the third, the fourth, or the fifth exemplary embodiment.

This example includes an active-type RFID tag that has a button cell as an electric power, and transmits the identification information (unique ID) by use of the wireless communication every constant time interval (for example, 0.5 second) as the mobile station 1 and the reference station 2, and an RFID reader capable of receiving the identification information from the RFID tag and measuring the reception strength (an integer value having 256 stages ranging from 0 to 255) as the base station 3. The position detection device 4 is realized with a personal computer, and a display is employed as the position detection result outputting device 5. The personal computer includes a central processing device that functions as the reception feature quantity generator 41, the mobile station/reference station judging unit 42, the position reception feature quantity learning unit 43, the position judging unit 45, and the position reception feature quantity selector 46, and a storage device that functions as the position reception feature quantity storage 44.

This example employs the active-type RFID system, and updates the by-area representative reception feature quantities by using the reception feature quantity as well that is obtained for the mobile station tag, in addition to the reception feature quantities that are obtained for the reference station tags even if there are few reference station tags installed in the environment, thereby making it possible to reflect a reception feature quantity distribution within the area, which cannot be obtained by the reference station tag, into the by-area representative reception feature quantities, and to realize the high precision of the position detection of the mobile body tag.

### EXAMPLE 2

Next, the example 2 of the present invention will be explained. Such an example corresponds to the sixth exemplary embodiment of the present invention.

This example includes a wireless LAN access point that transmits, as a beacon packet (broadcast packet), its own identification information (MAC address) every constant time interval (for example, 0.1 second) as the base station 3′, and a wireless LAN device that can receive the beacon packet including the identification information from the wireless LAN access point, measure the reception strength (dBm unit), and transmit the acquired identification information and the reception strength via the wireless LAN communication path to the position detection device 4′ as the mobile station 1′ and the reference station 2′. The position detection device 4′ is realized with a personal computer, and a display is employed as the position detection result outputting device 5. The personal computer includes a central processing device that functions as the reception feature quantity generator 41′, the mobile station/reference station judging unit 42, the position reception feature quantity learning unit 43, the position judging unit 45, and the position reception feature quantity selector 46, and a storage device that functions as the position reception feature quantity storage 44.

This example employs the wireless LAN system, and updates the by-area representative reception feature quantities by using the reception feature quantity as well that is obtained for the wireless LAN devices for the mobile station in addition to the reception feature quantities that are obtained for the wireless LAN devices for the reference station even if there are few wireless LAN devices for the reference station installed in the environment, thereby making it possible to reflect a reception feature quantity distribution within the area, which cannot be obtained by the wireless LAN device for the reference station, into the by-area representative reception feature quantities, and to realize the high precision of the position detection of the wireless LAN devices for the mobile body.

Above, although the present invention has been particularly described with reference to the preferred embodiments and the examples, it should be readily apparent to those of ordinary skill in the art that the present invention is not always limited to the above-mentioned embodiment and examples, and changes and modifications in the form and details may be made without departing from the spirit and scope of the invention.

In accordance with the above-mentioned present invention, a difference between the by-area representative reception feature quantity for judging the position and the reception feature quantity that is obtained for the mobile station can be alleviated even if there are few reference stations, and the position of the mobile station can be correctly detected. The reason is that updating the by-area representative reception feature quantities for judging the position by using the reception feature quantity as well obtained for the wireless machine attached to the mobile body makes it possible to reflect a reception feature quantity distribution within the area, which cannot be obtained from the reference wireless machine, into the by-area representative reception feature quantities for judging the position.

(Supplementary note 1) A position-determining device, including: a storage controlling unit that decides a reception feature quantity of each area pre-defined in a predetermined environment by employing the reception feature quantity of a mobile station in the above area calculated from radio wave strength of the mobile station attached to a mobile body that moves within said environment, and causes a feature quantity storing unit to store position information indicating a position of each area and the decided reception feature quantity correspondingly to each other; and

a position-determining unit that retrieves, from said feature quantity storing unit, the reception feature quantity approximating the reception feature quantity calculated from the radio wave strength of the mobile station attached to the mobile body that moves within said environment, and determines the position information caused to correspond to the retrieved reception feature quantity to be of the position of said mobile station.

(Supplementary note 2) The position-determining device according to Supplementary note 1, wherein said storage controlling unit causes a position information storing unit to store the reception feature quantity of each area calculated from the radio wave strength in a reference station installed in each area pre-defined in said environment and the position information indicating the position of the above area correspondingly to each other, retrieves the reception feature quantity approximating said calculated reception feature quantity of the mobile station, and causes said feature quantity storing unit to store the position information caused to correspond to the retrieved reception feature quantity and said calculated reception feature quantity of the mobile station correspondingly to each other.

(Supplementary note 3) The position-determining device according to Supplementary note 2, including a judging unit that evaluates a probability of at least one piece of the position information, out of pieces of the position information caused to correspond to the calculated reception feature quantities of the mobile station and the retrieved reception feature quantities, and judges whether to cause said feature quantity storing unit to store said calculated reception feature quantity of the mobile station and the position information caused to correspond to the retrieved reception feature quantity correspondingly to each other, responding to a result of the evaluation.

(Supplementary note 4) The position-determining device according to Supplementary note 3, wherein said judging unit employs a distance between a feature vector of the calculated reception feature quantity of the mobile station and that of the retrieved reception feature quantity, and evaluates said calculated reception feature quantity of the mobile station.

(Supplementary note 5) The position-determining device according to Supplementary note 3 or Supplementary note 4, wherein said judging unit employs said position information of the mobile station coming from a position information detection device for detecting the position information indicating the position of the mobile station at a high precision, and evaluates the position information caused to correspond to the retrieved reception feature quantity.

(Supplementary note 6) The position-determining device according to one of

Supplementary note 1 to Supplementary note 5, wherein said storage controlling unit employs the reception feature quantity of the mobile station calculated from reception strength of the information that said mobile station has transmitted to a base station installed in said environment by use of wireless communication.

(Supplementary note 7) The position-determining device according to one of Supplementary note 1 to Supplementary note 5, wherein said storage controlling unit employs the reception feature quantity of the mobile station calculated from reception strength of the information that a base station installed in said environment has transmitted to said mobile station by use of wireless communication.

(Supplementary note 8) The position-determining device according to one of Supplementary note 1 to Supplementary note 7, wherein said storage controlling unit calculates the reception feature quantity of each area from the reception strength of the information that said reference station has transmitted to the base station installed in said environment by use of the wireless communication.

(Supplementary note 9) The position-determining device according to one of Supplementary note 1 to Supplementary note 7, wherein said storage controlling unit calculates the reception feature quantity of each area from the reception strength of the information that the base station installed in said environment has transmitted to said reference station by use of the wireless communication.

(Supplementary note 10) The position-determining device according to one of Supplementary note 1 to Supplementary note 9, including:

a difference calculator that employs said position information of the mobile station coming from the position information detection device for detecting the position information indicating the position of the mobile station at a high precision, retrieves the reception feature quantity from said feature quantity storing unit, and calculates a difference between the retrieved reception feature quantity and the reception feature quantity calculated from the radio wave strength in said mobile station; and

an updating unit that reflects said calculated difference into said retrieved reception feature quantity, and updates said feature quantity storing unit.

(Supplementary note 11) A position-determining system, including:

a storage controlling unit that decides a reception feature quantity of each area pre-defined in a predetermined environment by employing the reception feature quantity of a mobile station in the above area calculated from radio wave strength of the mobile station attached to a mobile body that moves within said environment, and causes a feature quantity storing unit to store position information indicating a position of each area and the decided reception feature quantity correspondingly to each other; and

a position-determining unit that retrieves, from said feature quantity storing unit, the reception feature quantity approximating the reception feature quantity calculated from the radio wave strength of the mobile station attached to the mobile body that moves within said environment, and determines the position information caused to correspond to the retrieved reception feature quantity to be of the position of said mobile station.

(Supplementary note 12) The position-determining system according to Supplementary note 11, wherein said storage controlling unit causes a position information storing unit to store the reception feature quantity of each area calculated from the radio wave strength in a reference station installed in each area pre-defined in said environment and the position information indicating the position of the above area correspondingly to each other, retrieves the reception feature quantity approximating said calculated reception feature quantity of the mobile station, and causes said feature quantity storing unit to store the position information caused to correspond to the retrieved reception feature quantity and said calculated reception feature quantity of the mobile station correspondingly to each other.

(Supplementary note 13) The position-determining system according to Supplementary note 12, including a judging unit that evaluates a probability of at least one piece of the position information, out of pieces of the position information caused to correspond to the calculated reception feature quantities of the mobile station and the retrieved reception feature quantities, and judges whether to cause said feature quantity storing unit to store said calculated reception feature quantity of the mobile station and the position information caused to correspond to the retrieved reception feature quantity correspondingly to each other, responding to a result of the evaluation.

(Supplementary note 14) The position-determining system according to Supplementary note 13, wherein said judging unit employs a distance between a feature vector of the calculated reception feature quantity of the mobile station and that of the retrieved reception feature quantity, and evaluates said calculated reception feature quantity of the mobile station.

(Supplementary note 15) The position-determining system according to Supplementary note 13 or Supplementary note 14, wherein said judging unit employs said position information of the mobile station coming from a position information detection device for detecting the position information indicating the position of the mobile station at a high precision, and evaluates the position information caused to correspond to the retrieved reception feature quantity.

(Supplementary note 16) The position-determining system according to one of Supplementary note 11 to Supplementary note 15, wherein said storage controlling unit employs the reception feature quantity of the mobile station calculated from reception strength of the information that said mobile station has transmitted to a base station installed in said environment by use of wireless communication.

(Supplementary note 17) The position-determining system according to one of Supplementary note 11 to Supplementary note 15, wherein said storage controlling unit employs the reception feature quantity of the mobile station calculated from reception strength of the information that a base station installed in said environment has transmitted to said mobile station by use of wireless communication.

(Supplementary note 18) The position-determining system according to one of Supplementary note 11 to Supplementary note 17, wherein said storage controlling unit calculates the reception feature quantity of each area from the reception strength of the information that said reference station has transmitted to the base station installed in said environment by use of the wireless communication.

(Supplementary note 19) The position-determining system according to one of Supplementary note 11 to Supplementary note 17, wherein said storage controlling unit calculates the reception feature quantity of each area from the reception strength of the information that the base station installed in said environment has transmitted to said reference station by use of the wireless communication.

(Supplementary note 20) The position-determining system according to one of Supplementary note 11 to Supplementary note 19, including:

a difference calculator that employs said position information of the mobile station coming from the position information detection device for detecting the position information indicating the position of the mobile station at a high precision, retrieves the reception feature quantity from said feature quantity storing unit, and calculates a difference between the retrieved reception feature quantity and the reception feature quantity calculated from the radio wave strength in said mobile station; and

an updating unit that reflects said calculated difference into said retrieved reception feature quantity, and updates said feature quantity storing unit.

(Supplementary note 21) A position-determining method, including:

a storage controlling step of deciding a reception feature quantity of each area pre-defined in a predetermined environment by employing the reception feature quantity of a mobile station in the above area calculated from radio wave strength of the mobile station attached to a mobile body that moves within said environment, and causing a feature quantity storing unit to store position information indicating a position of each area and the decided reception feature quantity correspondingly to each other; and

a position-determining step of retrieving, from said feature quantity storing unit, the reception feature quantity approximating the reception feature quantity calculated from the radio wave strength of the mobile station attached to the mobile body that moves within said environment, and determining the position information caused to correspond to the retrieved reception feature quantity to be of the position of said mobile station.

(Supplementary note 22) The position-determining method according to Supplementary note 21, wherein said storage controlling step causes a position information storing unit to store the reception feature quantity of each area calculated from the radio wave strength in a reference station installed in each area pre-defined in said environment and the position information indicating the position of the above area correspondingly to each other, retrieves the reception feature quantity approximating said calculated reception feature quantity of the mobile station, and causes said feature quantity storing unit to store the position information caused to correspond to the retrieved reception feature quantity and said calculated reception feature quantity of the mobile station correspondingly to each other.

(Supplementary note 23) The position-determining method according to Supplementary note 22, including a judging step of evaluating a probability of at least one piece of the position information, out of pieces of the position information caused to correspond to the calculated reception feature quantities of the mobile station and the retrieved reception feature quantities, and judging whether to cause said feature quantity storing unit to store said calculated reception feature quantity of the mobile station and the position information caused to correspond to the retrieved reception feature quantity correspondingly to each other, responding to a result of the evaluation.

(Supplementary note 24) The position-determining method according to Supplementary note 23, wherein said judging step employs a distance between a feature vector of the calculated reception feature quantity of the mobile station and that of the retrieved reception feature quantity, and evaluates said calculated reception feature quantity of the mobile station.

(Supplementary note 25) The position-determining method according to Supplementary note 23 or Supplementary note 24, wherein said judging step employs said position information of the mobile station coming from a position information detection device for detecting the position information indicating the position of the mobile station at a high precision, and evaluates the position information caused to correspond to the retrieved reception feature quantity.

(Supplementary note 26) The position-determining method according to one of Supplementary note 21 to Supplementary note 25, wherein said storage controlling step employs the reception feature quantity of the mobile station calculated from reception strength of the information that said mobile station has transmitted to a base station installed in said environment by use of wireless communication.

(Supplementary note 27) The position-determining method according to one of Supplementary note 21 to Supplementary note 25, wherein said storage controlling step employs the reception feature quantity of the mobile station calculated from reception strength of the information that a base station installed in said environment has transmitted to said mobile station by use of wireless communication.

(Supplementary note 28) The position-determining method according to one of Supplementary note 21 to Supplementary note 27, wherein said storage controlling step calculates the reception feature quantity of each area from the reception strength of the information that said reference station has transmitted to the base station installed in said environment by use of the wireless communication.

(Supplementary note 29) The position-determining method according to one of Supplementary note 21 to Supplementary note 27, wherein said storage controlling step calculates the reception feature quantity of each area from the reception strength of the information that the base station installed in said environment has transmitted to said reference station by use of the wireless communication.

(Supplementary note 30) The position-determining method according to one of Supplementary note 21 to Supplementary note 29, including:

a difference calculating step of employing said position information of the mobile station coming from the position information detection device for detecting the position information indicating the position of the mobile station at a high precision, retrieving the reception feature quantity from said feature quantity storing unit, and calculating a difference between the retrieved reception feature quantity and the reception feature quantity calculated from the radio wave strength in said mobile station; and

an updating step of reflecting said calculated difference into said retrieved reception feature quantity, and updating said feature quantity storing unit.

(Supplementary note 31) A program of a position-determining device, said program causing said position-determining device to execute:

a storage controlling process of deciding a reception feature quantity of each area pre-defined in a predetermined environment by employing the reception feature quantity of a mobile station in the above area calculated from radio wave strength of the mobile station attached to a mobile body that moves within said environment, and causing a feature quantity storing unit to store position information indicating a position of each area and the decided reception feature quantity correspondingly to each other; and

a position-determining process of retrieving, from said feature quantity storing unit, the reception feature quantity approximating the reception feature quantity calculated from the radio wave strength of the mobile station attached to the mobile body that moves within said environment, and determining the position information caused to correspond to the retrieved reception feature quantity to be of the position of said mobile station.

This application is based upon and claims the benefit of priority from Japanese patent application No. 2009-279393, filed on Dec. 9, 2009, and Japanese patent application No. 2010-052879, filed on Mar. 10, 2010, the disclosure of which is incorporated herein in its entirety by reference.

### INDUSTRIAL APPLICABILITY

The present invention may be applied to applications such as a program for realizing a system that realizes the high precision and the low cost in acquiring the positions of people and things utilizing the position detection system by use of the wireless communication by employing the wireless machines installed in the environment for reference, and the like.

### REFERENCE SIGNS LIST

1 mobile station (wireless transmitter)

2 reference station (wireless transmitter)

3 base station (wireless receiver)

4 position detecting device

41 reception feature quantity generator

42 mobile station/reference station judging unit

43 position reception feature quantity learning unit

44 position reception feature quantity storage

45 position judging unit

46 position reception feature quantity selector

5 position detection result outputting device

6 mobile station related-position collecting device

1′ mobile station (wireless receiver)

2′ reference station (wireless receiver)

3′ base station (wireless transmitter)

4′ position detecting device

41′ reception feature quantity generator

7 position detection program

7′ position detection program

43′ position reception feature quantity learning unit

45′ position judging unit

47 difference feature quantity learning unit

48 difference feature quantity storage

49 position reception feature quantity generatorreception feature quantity generator

45″ position judging unit

1-13. (canceled)

14. A position-determining device, comprising:
a storage controlling unit that calculates a reception feature quantity of each area pre-defined in a predetermined environment from radio wave strength of the mobile station attached to a mobile body that moves within said environment, and causes a feature quantity storage to store position information indicating a position of each area and the calculated reception feature quantity correspondingly to each other; and
a position-determining unit that retrieves, from said feature quantity storage, the reception feature quantity approximating the reception feature quantity calculated from the radio wave strength of the mobile station attached to the mobile body that moves within said environment, and determines the position information caused to correspond to the retrieved reception feature quantity to be of the position of said mobile station, wherein said storage controlling unit decides, from a position of said mobile station determined by said position-determining unit and the reception feature quantity calculated from the radio wave strength of said mobile station, the reception feature quantity of the area equivalent to the above position, and causes said feature quantity storage to store the position information indicating the position of the above area and the decided reception feature quantity correspondingly to each other.

15. A position-determining device according to claim 14, wherein said storage controlling unit causes a position information storage to store the reception feature quantity of each area calculated from the radio wave strength in a reference station installed in each area pre-defined in said environment and the position information indicating the position of the above area correspondingly to each other.

16. A position-determining device according to claim 15, wherein said storage controlling unit comprises a judging unit that evaluates a probability of at least one piece of the position information, out of pieces of the position information caused to correspond to the reception feature quantities calculated from the radio wave strength of said mobile station and the reception feature quantities retrieved by said position-determining unit, and judges whether to cause said feature quantity storage to store said calculated reception feature quantity of the mobile station and the position information caused to correspond to the retrieved reception feature quantity correspondingly to each other, responding to a result of the evaluation.

17. A position-determining device according to claim 16, wherein said judging unit employs a distance between a feature vector of the reception feature quantity calculated from the radio wave strength of said mobile station and that of the reception feature quantity retrieved by said position-determining unit, and evaluates said calculated reception feature quantity of the mobile station.

18. A position-determining device according to claim 16, wherein said judging unit employs said position information of the mobile station coming from a position information detection device for detecting the position information indicating the position of the mobile station at a high precision, and evaluates the position information caused to correspond to the reception feature quantity retrieved by said position-determining unit.

19. A position-determining device according to claim 14, wherein said storage controlling unit calculates the reception feature quantity of said mobile station from reception strength of the information that said mobile station has transmitted to a base station installed in said environment by use of wireless communication.

20. A position-determining device according to claim 14, wherein said storage controlling unit calculates the reception feature quantity of said mobile station from reception strength of the information that a base station installed in said environment has transmitted to said mobile station by use of wireless communication.

21. A position-determining device according to claim 15, wherein said storage controlling unit calculates the reception feature quantity of said mobile station from reception strength of the information that a base station installed in said environment has transmitted to said mobile station by use of wireless communication.

22. A position-determining device according to claim 15, wherein said storage controlling unit calculates the reception feature quantity of each area from the reception strength of the information that the base station installed in said environment has transmitted to said reference station by use of the wireless communication.

23. A position-determining system, comprising:
a storage controlling unit that calculates a reception feature quantity of each area pre-defined in a predetermined environment from radio wave strength of the mobile station attached to a mobile body that moves within said environment, and causes a feature quantity storage to store position information indicating a position of each area and the calculated reception feature quantity correspondingly to each other; and
a position-determining unit that retrieves, from said feature quantity storage, the reception feature quantity approximating the reception feature quantity calculated from the radio wave strength of the mobile station attached to the mobile body that moves within said environment, and determines the position information caused to correspond to the retrieved reception feature quantity to be of the position of said mobile station, wherein said storage controlling unit decides, from a position of said mobile station determined by said position-determining unit and the reception feature quantity calculated from the radio wave strength of said mobile station the reception feature quantity of the area equivalent to the above position, and causes said feature quantity storage to store the position information indicating the position of the above area and the decided reception feature quantity correspondingly to each other.

24. A position-determining method, comprising:
a storage controlling step of calculating a reception feature quantity of each area pre-defined in a predetermined environment from radio wave strength of the mobile station attached to a mobile body that moves within said environment, and causing a feature quantity storage to store position information indicating a position of each area and the calculated reception feature quantity correspondingly to each other; and
a position-determining step of retrieving, from said feature quantity storage, the reception feature quantity approximating the reception feature quantity calculated from the radio wave strength of the mobile station attached to the mobile body that moves within said environment, and determining the position information caused to correspond to the retrieved reception feature quantity to be of the position of said mobile station, wherein said storage controlling step decides, from a position of said mobile station determined by said position-determining step and the reception feature quantity calculated from the radio wave strength of said mobile station, the reception feature quantity of the area equivalent to the above position, and causes said feature quantity storage to store the position information indicating the position of the above area and the decided reception feature quantity correspondingly to each other.

25. A program of a position-determining device, said program causing said position-determining device to execute:
a storage controlling process of calculating reception feature quantity of each area pre-defined in a predetermined environment from radio wave strength of the mobile station attached to a mobile body that moves within said environment, and causing a feature quantity storage to store position information indicating a position of each area and the calculated reception feature quantity correspondingly to each other; and
a position-determining process of retrieving, from said feature quantity storage, the reception feature quantity approximating the reception feature quantity calculated from the radio wave strength of the mobile station attached to the mobile body that moves within said environment, and determining the position information caused to correspond to the retrieved reception feature quantity to be of the position of said mobile station, wherein said storage controlling process decides, from a position of said mobile station determined by said position-determining process and the reception feature quantity calculated from the radio wave strength of said mobile station, the reception feature quantity of the area equivalent to the above position, and causes said feature quantity storage to store the position information indicating the position of the above area and the decided reception feature quantity correspondingly to each other.
